(19) United States
(12) Patent Application Publication
(10) Pub. No.: US 2019/0289915 A1
(43) Pub. Date: Sep. 26, 2019

(54) CROWDSOURCED DATA FOR VAPORIZERS

(71) Applicant: NATIONAL CONCESSIONS GROUP INC., DENVER, CO (US)

(72) Inventors: JEREMY HEIDL, DENVER, CO (US); MIKE ECKLES, DENVER, CO (US)

(73) Assignee: NATIONAL CONCESSIONS GROUP INC., DENVER, CO (US)

(21) Appl. No.: 16/362,206

(22) Filed: Mar. 22, 2019

Related U.S. Application Data
(60) Provisional application No. 62/647,522, filed on Mar. 23, 2018.

(51) Int. Cl. A24F 47/00; H05B 1/02; G06F 3/01; H04W 4/38

(52) U.S. Cl. CPC A24F 47/008; H04W 4/38; G06F 3/017; H05B 1/0297

(57) ABSTRACT

A vaporizer device including a body having a mouthpiece, a power source, a regulator coupled to the power source, a cavity configured to receive a vaporizer cartridge, and one or more airflow pathways configured to interconnect with an airflow coupler associated with a vaporizer cartridge. The vaporizer device may include a sensor configured to detect a pressure change in the one or more airflow pathways between the vaporizer cartridge and the mouthpiece. The vaporizer device may include a controller configured to control the regulator, and a data interface coupled to the processor, the data interface being configured to contact a receiving portion of a vaporizer cartridge when the vaporizer cartridge is inserted into the cavity.

### CROSS-REFERENCE TO RELATED APPLICATIONS

This application claims the benefit of priority from U.S. patent application Ser. No. 62/647,522, filed Mar. 23, 2018, the entire disclosure of which is hereby incorporated by reference.

### FIELD

The present disclosure generally relates to vaporizer devices and to systems and methods for obtaining and modifying data for use with a vaporizer device. More specifically, the present disclosure provides unique vaporizer base unit with replaceable oil carrying cartridges and methods and systems for obtaining data and modifying one or more configurations of vaporizer devices.

### BACKGROUND

In recent years, electronic cigarettes and vaporizers have become an increasingly popular alternative to traditional smoking. Among other reasons, vaporizers and electronic cigarettes are perceived as a healthier alternative to traditional smoking because they allow for inhalation of the desirable chemicals without having to inhale the harsh chemicals found in cigarettes and cigarette smoke.

### SUMMARY

It is an object of the present disclosure to provide a vaporizer device comprising a base unit compatible with replaceable oil carrying cartridges and, more specifically, where a mouthpiece is formed integral with the base unit and not the cartridge. Moreover, it is an object of the present disclosure to provide a base unit and integral mouthpiece that is compatible simultaneously with multiple oil carrying cartridges. Further, it is an object of the present disclosure to obtain one user configuration and customization settings for a vaporizer device and/or cartridge and provide a selectable amount of power to a heating element of the vaporizer device and/or cartridge based on multiple collected user configuration and customization settings. Moreover, it is an object of the present disclosure to store or otherwise locate a vaporizer cartridge vaporizing profile at a memory of a removable vaporizer cartridge.

In accordance with at least one embodiment of the present disclosure, a vaporizer device is provided. The vaporizer device may include a body having a mouthpiece, a power source, a regulator coupled to the power source, a cavity configured to receive a vaporizer cartridge, and one or more airflow pathways configured to interconnect with an airflow coupler associated with a vaporizer cartridge. At least one aspect of the above embodiment may include a sensor configured to detect a pressure change in the one or more airflow pathways between the vaporizer cartridge and the mouthpiece. An additional aspect of the above embodiment may include a controller configured to control the regulator, and a data interface coupled to the processor, the data interface being configured to contact a receiving portion of a vaporizer cartridge when the vaporizer cartridge is inserted into the cavity. At least one aspect of the above embodiment may include where the data interface is configured to contact a receiving portion of a second vaporizer cartridge when both vaporizer cartridges are inserted into the cavity. An additional aspect of the above embodiment may include a controller configured to control the regulator, and a power interface coupled to the regulator, the power interface configured to contact a receiving portion of a vaporizer cartridge when the vaporizer cartridge is inserted into the cavity. At least one aspect of the above embodiment may include where the power interface is configured to contact a receiving portion of a second vaporizer cartridge when both vaporizer cartridges are inserted into the cavity. An additional aspect of the above embodiment may include a controller including a processor and memory, the memory including one or more instructions, which when executed by the processor, cause the processor to communicate with a vaporizer cartridge when the vaporizer cartridge is inserted into the cavity. At least one aspect of the above embodiment may include a vaporizer cartridge removably connected to the cavity, where the vaporizer cartridge includes a reservoir containing a vaporizable material, an atomizer for vaporizing the vaporizable material, and an airflow coupler in fluid communication with the one or more airflow pathways of the body and the reservoir. An additional aspect of the above embodiment may include where the vaporizer cartridge includes a cartridge memory, and where the cartridge memory is configured to receive at least one operating parameter provided from the processor of the controller. At least one aspect of the above embodiment where the at least one operating parameter provided from the processor of the controller is an operating profile including a plurality of set points, each set point of the plurality of set points corresponding to an amount of heat to be generated by a heating element of the cartridge at a point in time. An additional aspect of the above embodiment may include where the controller is configured to retrieve at least a portion of an operating profile from the cartridge memory, where the at least a portion of the operating profile includes a plurality of set points, each set point of the plurality of set points corresponding to an amount of heat to be generated by a heating element of the cartridge at a point in time. At least one aspect of the above embodiment may include where the controller is configured to control the regulator and a heating element of the cartridge in accordance with the operating profile. An additional aspect of the above embodiment may include an input receiving device coupled to the controller, wherein the operating profile is selected based on an input received from the input receiving device. At least one aspect of the above embodiment may include a communication interface configured to receive the at least one operating profile. An additional aspect of the above embodiment may include where the vaporizer device is paired with a communication device, and where the communication device provides the vaporizer device with the at least one operating profile.

In accordance with at least one embodiment of the present disclosure, a vaporizer device is provided. The vaporizer device may include a vaporizer device body including a mouthpiece disposed at a first end of the body, a power source, a regulator coupled to the power source, a cavity disposed at a second end of the body, wherein the second end is opposite the first end, the cavity configured to receive a vaporizer cartridge, and one or more airflow pathways having a first end and a second end, the first end in fluid communication with the mouthpiece and the second end in fluid communication with an airflow fitting. The vaporizer device may include a vaporizer cartridge inserted into the cavity, the vaporizer cartridge including a reservoir, a heating element configured to vaporize a substance in the reservoir, at least one airflow connector in fluid communication with the one or more airflow fittings of the body, a data interface, and a memory coupled to the data interface, wherein the memory includes a plurality of operating profiles. At least one aspect of the above embodiment includes a crowd sourced data platform configured to provide the one or more operating profiles. An additional aspect of the above embodiment may include where the crowd sourced data platform is configured to receive one or more operating profiles communicated from the vaporizer device, where the one or more operating profiles including a plurality of set points, each set point of the plurality of set points corresponding to an amount of heat to be generated by a heating element of the cartridge at a point in time. At least one aspect of the above embodiment may include where the crowd sourced data platform is configured to produce a new operating profile by combining the received one or more operating profiles communicated from the vaporizer device with one or more operating profiles communicated from another vaporizer device. An additional aspect of the above embodiment may include where the crowd sourced data platform is configured to communicate the new operating profile to the vaporizer device. At least one aspect of the above embodiment may include where the vaporizer device is configured to communicate the new operating profile to the memory of the vaporizer cartridge. An additional aspect of the above embodiment may include where the data interface, power interface and at least one airflow connector are disposed on the same side of the cartridge. At least one aspect of the above embodiment may include two vaporizer cartridges disposed within the cavity of the body.

In accordance with at least one embodiment of the present disclosure, a vaporizer cartridge is provided. The vaporizer device may include a reservoir, a heating element configured to vaporize a substance in the reservoir, an airflow path for removing vapor from proximate the heating element, a data interface, a power interface coupled to the heating element, and a memory coupled to the data interface, wherein the memory includes a plurality of operating profiles, the vaporizer cartridge is configured to be removably connected to a receiving cavity of a vaporizer device and the airflow path is configured to communicate with an airflow path in the vaporizer device. An additional aspect of the above embodiment may include where the vaporizer cartridge is configured to communicate at least a portion of a selected operating profile to a controller of the vaporizer device. An additional aspect of the above embodiment may include where the memory includes at least two memory portions, a first memory portion of the plurality of memory portions configured to store at least one default operating profile and a second memory portion of the plurality of memory portions configured to store at least one user provided operating profile. At least one aspect of the above embodiment may include where the default operating profile resides in the first memory portion prior to the vaporizer cartridge being inserted into the receiving cavity of the vaporizer device for a first time. An additional aspect of the above embodiment may include where the data interface, power interface and airflow path are disposed on the same side of the vaporizer cartridge.

### BRIEF DESCRIPTION OF THE DRAWINGS

The accompanying drawings, which are incorporated in and constitute a part of the specification, illustrate embodiments of the disclosed system and, together with the general description of the disclosure given above and the detailed description of the drawings given below, serve to explain the principles of the disclosure.

FIG. 1 illustrates a system for providing crowd sourced data for one or more vaporizers in accordance with at least one embodiment of the present disclosure;

FIG. 2 illustrates additional details of the system for providing crowd sourced data for one or more vaporizers in accordance with at least one embodiment of the present disclosure;

FIG. 3 depicts a hierarchical system diagram of a crowd sourced data platform in accordance with at least one embodiment of the present disclosure,

FIG. 4 depicts a block diagram of a vaporizer cartridge in accordance with at least one embodiment of the present disclosure;

FIG. 5A depicts a block diagram of a vaporizer device body in accordance with at least one embodiment of the present disclosure;

FIG. 5B depicts a block diagram of a vaporizer device body in accordance with at least one embodiment of the present disclosure;

FIG. 5C depicts a block diagram of a vaporizer device body in accordance with at least one embodiment of the present disclosure;

FIGS. 5D-F depict block diagrams of a vaporizer device body in accordance with at least one embodiment of the present disclosure;

FIG. 6 depicts a block diagram of a communication device in accordance with at least one embodiment of the present disclosure;

FIG. 7 depicts a block diagram of at least one server of a crowd sourced data platform in accordance with at least one embodiment of the present disclosure;

FIG. 8 depicts a first user interface of an app or application in accordance with at least one embodiment of the present disclosure;

FIG. 9 depicts a second user interface of an app or application in accordance with at least one embodiment of the present disclosure;

FIG. 10 depicts a third user interface of an app or application in accordance with at least one embodiment of the present disclosure;

FIG. 11 depicts a fourth user interface of an app or application in accordance with at least one embodiment of the present disclosure;

FIGS. 12A-B depict a fifth user interface of an app or application in accordance with at least one embodiment of the present disclosure;

FIGS. 13A-B depict a sixth user interface of an app or application in accordance with at least one embodiment of the present disclosure;

FIGS. 14A-B depict details of user interface of an app or application in accordance with at least one embodiment of the present disclosure;

FIG. 15 depicts a seventh user interface of an app or application in accordance with at least one embodiment of the present disclosure;

FIG. 16A depicts a block diagram of a single cartridge vaporizer device in accordance with at least one embodiment of the present disclosure;

FIG. 16B depicts a block diagram of a single cartridge vaporizer device in accordance with at least one embodiment of the present disclosure;

FIG. 17A depicts a block diagram of a dual cartridge vaporizer device in accordance with at least one embodiment of the present disclosure;

FIG. 17B depicts a block diagram of a dual cartridge vaporizer device in accordance with at least one embodiment of the present disclosure;

FIG. 18 depicts details of one or more data structures in accordance with at least one embodiment of the present disclosure;

FIG. 19 depicts details of one or more processes utilized in connection with the crowd sourced data platform in accordance with at least one embodiment of the present disclosure;

FIG. 20 depicts a first flow or process diagram of a method in accordance with at least one embodiment of the present disclosure;

FIG. 21 depicts a second flow or process diagram of a method in accordance with at least one embodiment of the present disclosure;

FIG. 22 depicts a third flow or process diagram of a method in accordance with at least one embodiment of the present disclosure;

FIG. 23 depicts a fourth flow or process diagram of a method in accordance with at least one embodiment of the present disclosure; and

FIG. 24 depicts a fifth flow or process diagram of a method in accordance with at least one embodiment of the present disclosure.

In certain instances, details that are not necessary for an understanding of the disclosure or that render other details difficult to perceive may have been omitted. It should be understood, of course, that the disclosure is not necessarily limited to the particular system embodiments illustrated herein.

### DETAILED DESCRIPTION

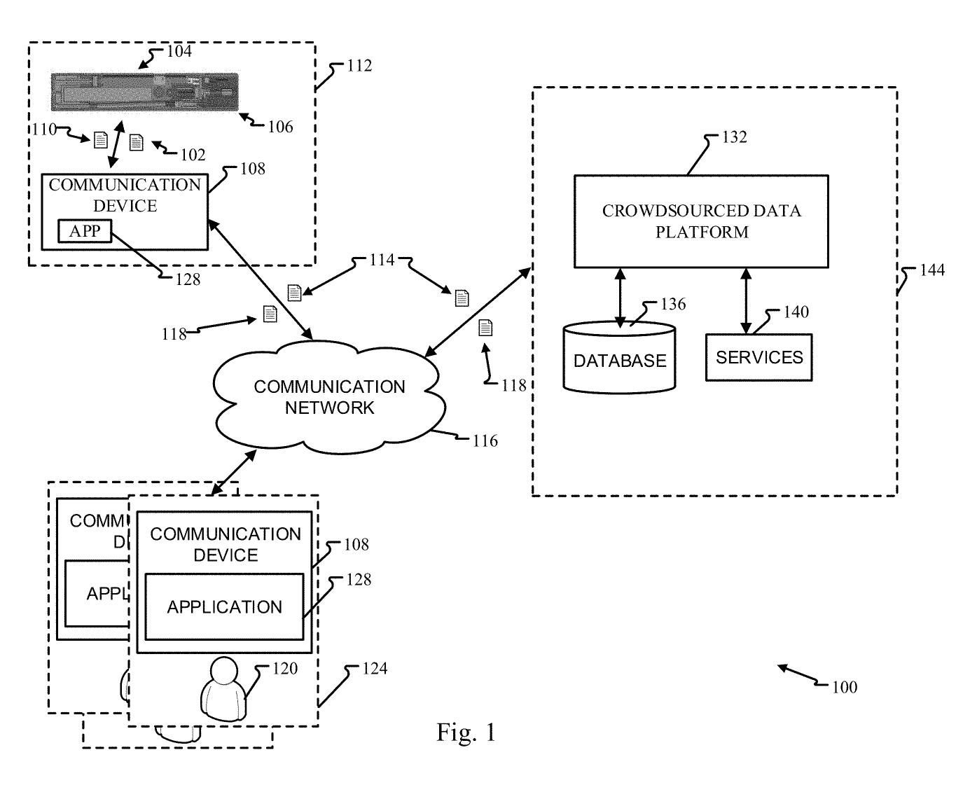

Referring initially to FIG. 1, a system 100 for providing crowd sourced data for one or more vaporizers is illustrated in accordance with at least one embodiment of the present disclosure. The system 100 for providing crowd sourced data for one or more vaporizers generally includes at least one vaporizer device 104 having a removable vaporizer cartridge 106, paired with an application, or app, 128 executing on a communication device 108 that communicates with one or more application/data servers 144 utilizing a communication network 116. The communication device 108 may comprise any type of known communication equipment or collection of communication equipment. Examples of a suitable communication device 108 may include, but are not limited to, a smart phone, a personal computer and/or laptop, a cellular phone, a tablet, or other device that can make or receive communications and capable of being paired with one or more vaporizer devices 104. Examples of a communication network 116 include, without limitation, a Wide Area Network (WAN), such as the Internet, a Local Area Network (LAN), a Personal Area Network (PAN), a cellular communications network, an IP Multimedia Subsystem (IMS) network, or combinations thereof. The Internet is an example of the communication network 116 that constitutes an Internet Protocol (IP) network including many computers, computing networks, and other communication devices located all over the world. In addition, it can be appreciated that the communication network 116 need not be limited to any one network type, and instead may be comprised of a number of different networks and/or network types. In general, each communication device 108 may provide many capabilities to one or more users of the vaporizer device 104 who desire to interact with the vaporizer device 104 and/or the crowd sourced data platform 132.

In accordance with embodiments of the present disclosure, the crowd sourced data platform 132 may reside within the server 144 and may further interact with a database 136 and/or a services module 140. The database 136 may include information pertaining to a user of the vaporizer device 104, while the services module 140 may allow access to such information in the database 136. In some instances, data in the database 136 may be accessed utilizing one or more services modules 140 and the application, or app, 128 executing on the communication device 108. Accordingly, a user of the vaporizer device 104 may access such information. Although FIG. 1 depicts a single database 136 and a single services module 140, it should be appreciated that one or more servers 144 may include one or more services module 140 and one or more databases 136.

In accordance with at least one embodiment of the present disclosure, the vaporizer device 104 may communicate information 102 to the application, or app, 128 executing on the communication device 108 utilizing one or more communication protocols. As will be described below, the vaporizer device 104 may be communicatively paired with the communication device 108, allowing the application, or app, 128 executing on the communication device 108 to communicate with the vaporizer device 104 and the vaporizer device 104 to communicate with the application, or app, 128 executing on the communication device 108. The communication pairing between the vaporizer device 104 and the communication device 108 may include, but is not limited to, Bluetooth®, near-field communication (NFC), infrared wireless (IrDA0, Ultra-Wideband (UWB), induction wireless, Wi-Fi, Wi-Fi direct, and combinations thereof. Moreover, a first network segment and a first communication type may facilitate communication between the vaporizer device 104 and the application, or app, 128 executing on the communication device 108, while a second network segment and a second communication type may facilitate communication between the application, or app, 128 executing on the communication device 108 and the crowd sourced data platform 132. Alternatively, or in addition, the vaporizer device 104 may communicate with the communication device 108 utilizing the communication network 116. Alternatively, or in addition, the vaporizer device 104 may communicate with the communication device 108 utilizing a wired connection, such as one or more Universal Serial Bus® (“USB”) protocols (e.g., USB Type A, Type B, Type C) and/or wired communication protocols. For example, the vaporizer device 104 may be capable of charging via the wired connection. The vaporizer device 104 may also be capable of communicating with a communication device 108 via the wired communication element. For example, software updates, firmware updates, operating system data, user settings, user data, etc. may be sent between the memory of the vaporizer device 104 and a communication device 108 over USB or another wired or wireless communication protocol.

The communicated information 102 may be associated with a user profile 124. The user profile 124 may include profile information that pertains to the to one or more users of the vaporizer device 104. Moreover, communicated information 114 may be transmitted to the crowd sourced data platform 132 via the communication network 116 and stored in the database 136. In accordance with at least one embodiment of the present disclosure, vaporizer cartridge information from multiple vaporizer devices 104 may be transmitted as communicated information 114 and may be stored at the database 136. In some instances, the vaporizer cartridge information from the vaporizer device 104 may be associated with one or more user profiles 124; such vaporizer cartridge information may be stored at the database 136. The vaporizer cartridge information may include, but is not limited to, vaporizer cartridge configuration and settings data, vapor cartridge and vaporizer device identification data, vaporizer use data, vaporizer cartridge vaporizing profiles for one or more vaporizer cartridges 106 associated with the vaporizer device 104, and the communicated information 102 communicated by the vaporizer device 104 to the application, or app, 128 executing on the communication device 108. Vaporizer cartridge information from multiple vaporizer devices 104 may be processed at the crowd sourced data platform 132 such that processed and/or default vaporizer cartridge information may be provided back to the application, or app, 128 executing on the communication device 108, as communicated information 118, where the application, or app, 128 executing on the communication device 108 provides the communicated information 110 to the vaporizer device 104 utilizing a wireless and/or wired mode of communication as previously described. The vaporizer cartridge 106 of the vaporizer device 104 may receive the communicated information 110 and may store such information, as will be described below.

In accordance with at least one embodiment of the present disclosure, the communicated information may include one or more default vaporizer cartridge vaporizing profiles that has been assembled by the crowd sourced data platform 132 utilizing crowd sourced information. The crowd sourced data platform 132 may transmit the one or more default vaporizer cartridge vaporizing profiles as communicated information 118, to the application, or app, 128 executing on the communication device 108 via the communication network 116. The application, or app, 128 executing on the communication device 108 may then provide the vaporizer device 104 with the one or more default vaporizer cartridge vaporizing profiles as communicated information 110. The vaporizer cartridge 106 of the vaporizer device 104 may receive the one or more default vaporizer cartridge vaporizing profiles and may store such information, as will be described below.

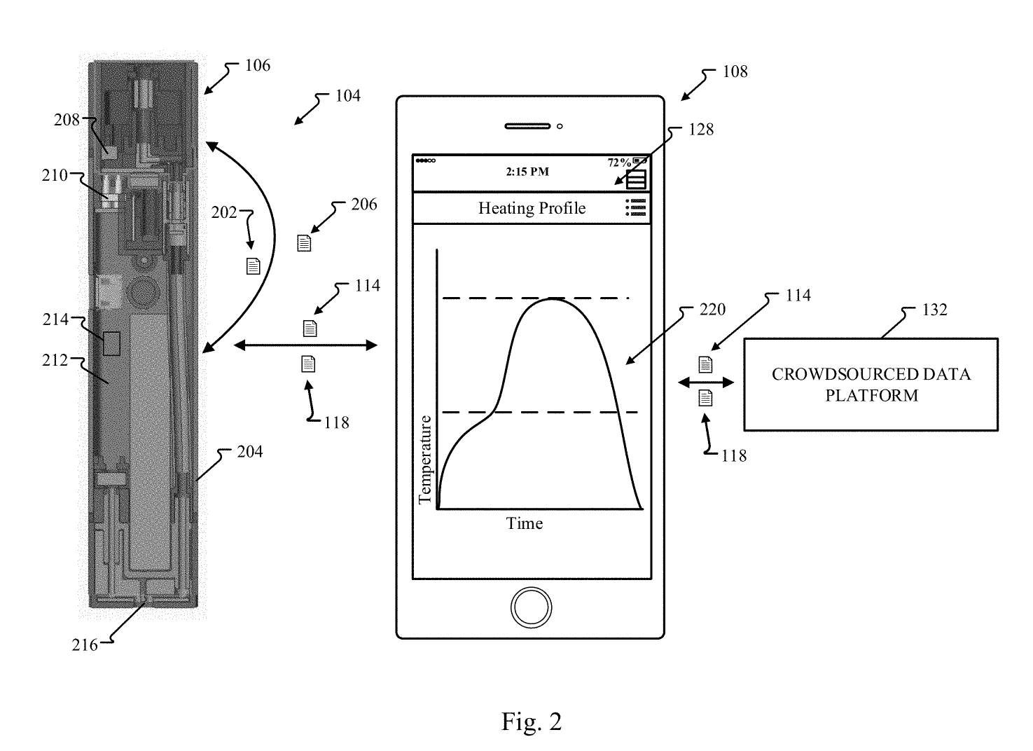

As further illustrated in FIG. 2, and in accordance with at least one embodiment of the present disclosure, a vaporizer cartridge vaporizing profile 220 may be provided by the crowd sourced data platform 132 to the application, or app, 128 executing on the communication device 108. The vaporizer cartridge vaporizing profile 220 of FIG. 2 may be illustrative of a temperature profile to be utilized during a puff or draw event. When a puff or draw event transpires at the vaporizer device 104, a vaporizing material within the vaporizer cartridge 106 is vaporized at a heating element such that a consumer, or vaporizer user 104, may inhale vapors of the vaporized material. That is, the heating element of the vaporizer device 104 located in the vaporizer cartridge 106 generally heats the substance, or material, to be vaporized to a temperature of vaporization. The vapors of the vaporized material may be obtained in the vaporizer cartridge 106 and flow through the vaporizer device body 204 to the mouthpiece 216, as will be described below.

In accordance with at least one embodiment of the present disclosure, the vaporizing substance, or material, within the vaporizer cartridge 106 may be a mixture of various vaporizing components having different temperatures of vaporization. As different active components within a mixture of various vaporizing substances, or materials, are released at different temperatures, a vaporizer cartridge vaporizing profile 220 may provide a means for controlling the temperature and therefore controlling the release of the different active components at each temperature within the vaporizer cartridge vaporizing profile 220.

As previously described, crowd sourced information, as well as other user profile information, may be communicated to the vaporizer device 104 from the application, or app, 128 executing on the communication device 108 as communicated information 118. The communicated information 118 may include one or more vaporizer cartridge vaporizing profiles 220 assembled from vaporizing profiles obtained from multiple vaporizer devices 104 and vaporizer cartridges 106. Moreover, one or more of the vaporizer cartridge vaporizing profiles 220 may be provided as a default vaporizer cartridge vaporizing profile 220 to be loaded and stored at a memory 208 of the vaporizer cartridge 106. Accordingly, one or more default vaporizer cartridge vaporizing profiles 220 may be included in the communicated information 118 from the crowd sourced data platform 132 to the application, or app, 128 executing on the communication device 108; the communicated information 118 including the one or more default vaporizer cartridge vaporizing profiles 220 may be provided to a memory 214 communicatively coupled to a printed circuit board 212 of the vaporizer device 104. Accordingly, during a synchronization event, or vaporizer cartridge vaporizing profile 220 update, the one or more default vaporizer cartridge vaporizing profiles 220 may be provided from the memory 214 of the printed circuit board 212 to the memory 208 of the vaporizer cartridge 106 as information 202. The memory 214 and/or the printed circuit board 212 may be communicatively coupled to the memory 208 via one or more data and power assemblies 210.

To make use of the one or more default vaporizer cartridge vaporizing profiles 220, the vaporizer device 104, when activated, transfers a selected default vaporizer cartridge vaporizing profile 220 from the memory 208 of the vaporizer cartridge 106 to the memory 214 of the printed circuit board 212. In accordance with at least one embodiment of the present disclosure, one or more processors/controllers may utilize temperature, heat, current, and or wattage settings of the default vaporizer cartridge vaporizing profile 220 to control a heating element of the vaporizer cartridge 106, as will be described further below. Accordingly, upon detection of a draw or puff event, the vaporizer device body 204 by means of the printed circuit board 212 may configure a heating element of the vaporizer cartridge 106 according to the default vaporizer cartridge vaporizing profile 220.

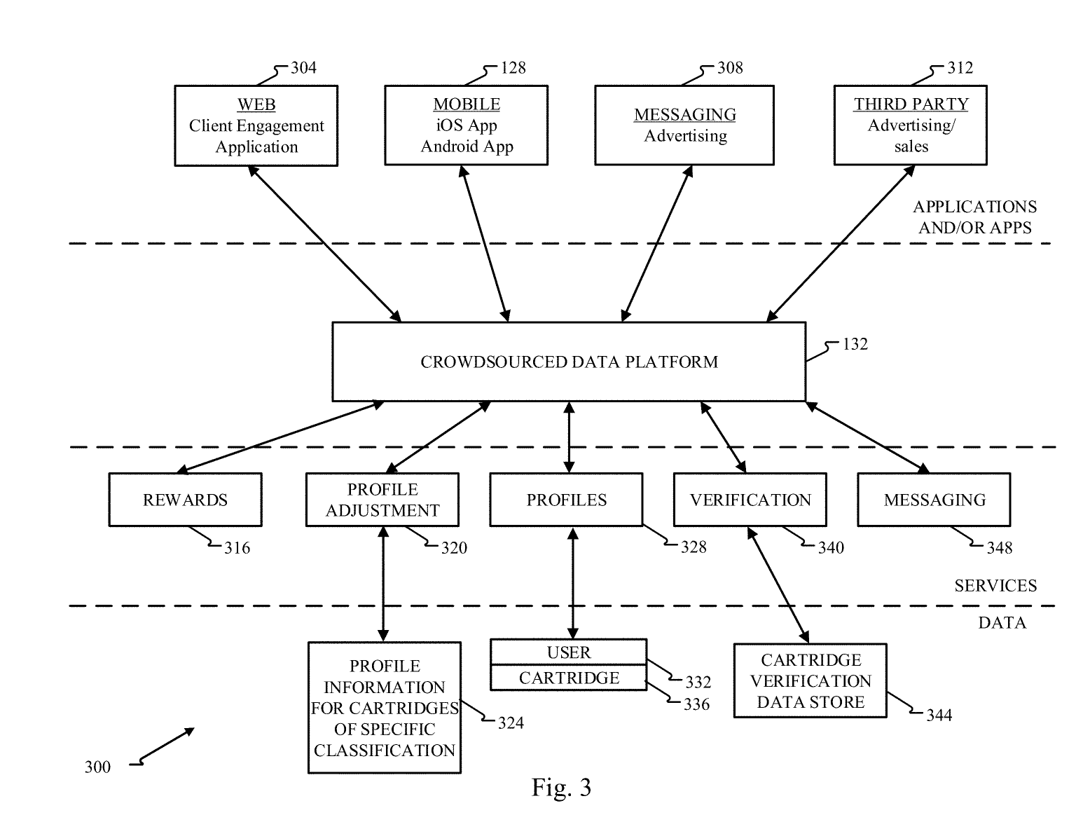

FIG. 3 depicts a hierarchical system diagram 300 in accordance with at least one embodiment of the crowd sourced data platform 132. The system 300 depicts the interaction of the application, or app, 128 executing on the communication device 108 and the crowd sourced data platform 132. FIG. 3. Further illustrates the interaction between the services 140 and the crowd sourced data platform 132, as well as the interaction between the data in the database 136, the services module 140, and the crowd sourced data platform 132. In accordance with embodiments of the present disclosure, the data stored within the database 136 may include, but is not limited to, profile information for vaporizer cartridges of a specific classification, consumer and cartridge profile data 332 and 336, and cartridge verification data. In accordance with embodiments of the present disclosure, the crowd sourced data platform 132 may rely on one or more services to access such data and provide such data to the crowd sourced data platform 132. Accordingly, a user 120 may utilize the crowd sourced data platform 132 and/or application, or app, 128 executing on the communication device 108 to access and/or provide data to the database 136.

For example, a user 120, may utilize the application, or app, 128 executing on the communication device 108 to indicate, make one or more changes to a vaporizer cartridge vaporizing profile. Such data may be received at the crowd sourced data platform 132 and associated with a user profile 332 belonging to or otherwise associated with the user 120. The user profile 332 may be the same as or similar to the user profile 124. Alternatively, or in addition, the crowd sourced data platform 132 may receive an indication that indicates a particular vaporizer cartridge 106 has been associated with a user profile 332. Accordingly, the crowd sourced data platform 132 may communicate such assignment to a rewards service 316 of a client engagement and loyalty platform where a user may be awarded loyalty points, as discussed further in U.S. Patent Publication No.: 2017/0249657 entitled, CLIENT ENGAGEMENT AND LOYALTY PLATFORM, which is hereby incorporated by reference for all that it teaches and for all purposes.

In accordance with at least one embodiment of the present disclosure, the profile adjustment service 320 may rely on data for many vaporizer cartridges 106. That is, the profile adjustment service may consume crowd sourced data, such as vaporizer cartridge vaporizing profile that have been adjusted or otherwise changed from a default profile. For example, initial manufacturer or factory data may reside at a memory 208 of the vaporizer cartridge. A user may use the vaporizer device 104, where the operation settings may be output to the application, or app, 128 executing on the communication device 108. The application, or app, 128 executing on the communication device 108 may display one or more configuration settings of a vaporizer cartridge vaporizing profile to a user, where a user may change one or more temperature setpoints. Accordingly, the application, or app, 128 executing on the communication device 108 may provide the temperature setpoints and additional profile information to the crowd sourced data platform 132, where the crowd sourced data platform 132 may compile data for vaporizer cartridge vaporizing profiles for cartridges of the same classification. The crowd sourced data platform 132 may process such data in order to arrive at a new vaporizer cartridge vaporizing profile. For example, the crowd sourced data platform 132 may average all user provided vaporizer cartridge vaporizing profile for a vaporizer cartridge of the same class. The new default vaporizer cartridge vaporizing profile may be provided to the memory 424.

The crowd sourced data platform 132 may also verify that a vaporizer cartridge vaporizing profile of a vaporizer cartridge 106 has been updated to include the new processed vaporizer cartridge vaporizing profile. That is, an application, or app, 128 executing on the communication device 108 may verify that the vaporizer cartridge vaporizing profile residing at the vaporizer cartridge 106 is the latest one to be issued by a manufacturer. Accordingly, the verification service340 may store such verification information in the cartridge verification data store 344. Alternatively, or in addition, the verification service 340 may ensure that a particular vaporizer cartridge 106 has not been recalled for some unintended reason.

In accordance with embodiments of the present disclosure, a messaging service 348 may be utilized to push and/or send SMS messages to a communication device 108 of a user 120. Such message may request a user 120 to provide feedback with respect to one or more vaporizer cartridge vaporizing profiles. The one or more users 120 may be grouped based on one or more characteristics or other information residing within their profile 332. Accordingly, a default vaporizer cartridge vaporizing profile for a vaporizer cartridge 106 of a first classification and for a first user may be different from a default vaporizer cartridge vaporizing profile for a vaporizer cartridge 106 of the same first classification but for a different second user.

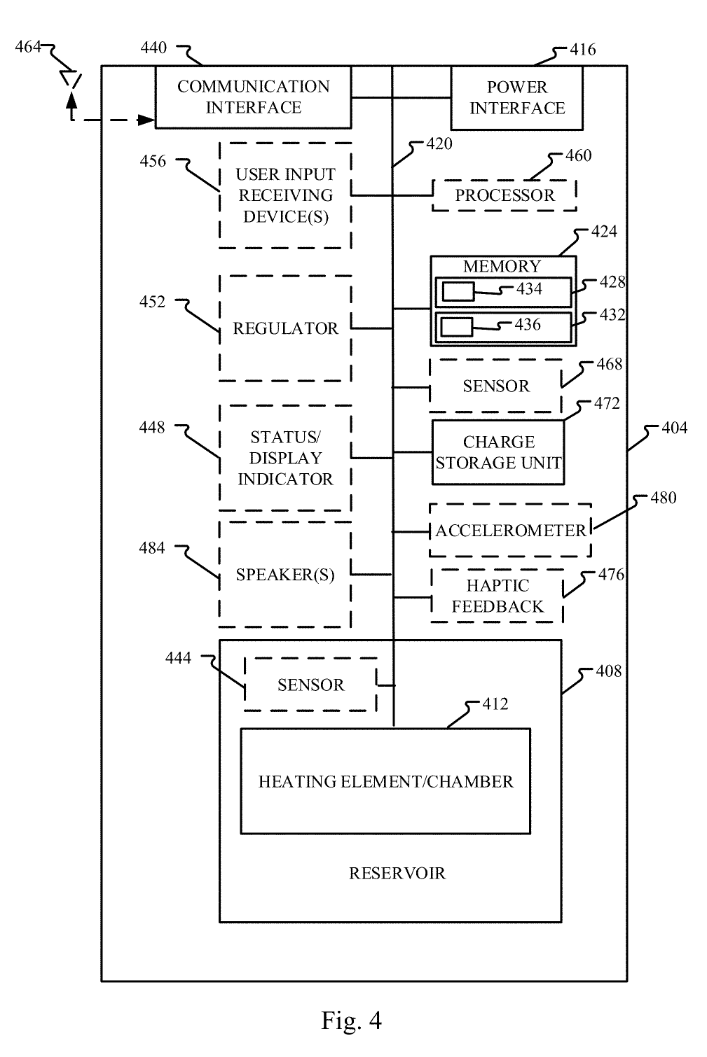

FIG. 4 depicts a block diagram of a vaporizer cartridge 404 in accordance with at least one embodiment of the present disclosure. The vaporizer cartridge 404 may be the same as, or similar to the previously described vaporizer cartridge 106. The vaporizer cartridge 404 generally includes one or more reservoirs 408 containing a substance to be vaporized. The vaporizer cartridge 404 generally includes at least one heating element 412, also referred to as a heating chamber communicatively coupled to a power interface 416. The heating element 412 generally heats the substance to be vaporized to the temperature of vaporization. The temperature of the heating element 412 may be controlled and/or regulated by the temperature regulator 452. Accordingly, the temperature regulator 452 may receive power from the power interface 416 and control a voltage and/or current provided to the heating element 412 thereby regulating a respective temperature of the heating element 412.

In accordance with at least one embodiment of the present disclosure, the heating element 412 may heat the substance to be vaporized in accordance with a vaporizer cartridge vaporizing profile 220. One or more vaporizer cartridge vaporizing profiles 220 may be stored and/or maintained at the memory 424. More specifically, the memory 424 may include distinct memory partitions such that a first memory location 428 may be accessed and/or maintained by a third party, such as a manufacturer of the vaporizer cartridge 404, and a second memory location 432 may be accessed and/or maintained by a user. Accordingly, a first verification procedure may need to be performed to update or otherwise change the contents of the first memory location 428, while a second different verification procedure may need to be performed to update or otherwise change the contents of the second memory location 432. Each of the first memory location 428 and the second memory location 432 may include one or more vaporizer cartridge vaporizing profiles 220. That is, the first memory location 428 may include a default vaporizer cartridge vaporizing profile 434 while the second memory location 432 may include a user provided vaporizer cartridge vaporizing profile 436. The default vaporizer cartridge vaporizing profile 434 may be maintained by a third party and/or manufacturer. More particularly, the default vaporizer cartridge vaporizing profile 434 may include a default vaporizer cartridge vaporizing profile that was assembled at the crowd sourced data platform 132 utilizing vaporizer cartridge vaporizing profiles from many vaporizer cartridges. As previously described, and as will be further described below, at least one of the default vaporizer cartridge vaporizing profile 434 and/or user provided vaporizer cartridge vaporizing profile 436 may control or regulate a temperature of the heating element 412. Accordingly, a printed circuit board 212 may be communicatively coupled to the memory 424 through the communication interface 440. The power interface 416 and the communication interface 440 may comprise the one or more data and power assemblies 210. Therefore, a controller of the vaporizer device body 204 may access one or more of the first memory location 428 and/or second memory location 432 to retrieve the default vaporizer cartridge vaporizing profile 434 and/or the user provided vaporizer cartridge vaporizing profile 436. The controller in the vaporizer device body 204 may then communicate with the regulator 452 to control a temperature of the heating element 412.

In accordance with at least one embodiment of the present disclosure, the contents, either whole or in part, of the memory 424 may be copied and/or transferred to the memory 214 of the vaporizer device body 204 utilizing the communication interface 440 when the vaporizer device 104 is switched to an “ON” mode or otherwise readied for use. Accordingly, a controller of the vaporizer device body 204 may access the default vaporizer cartridge vaporizing profile 434 and/or the user provided vaporizer cartridge vaporizing profile 436 from the memory 214 to communicate with the regulator 452 to control the temperature of the heating element 412. Alternatively, or in addition, a controller of the vaporizer device body 204 may access a portion of the default vaporizer cartridge vaporizing profile 434 and/or user provided vaporizer cartridge vaporizing profile 436, whereby a portion of the default vaporizer cartridge vaporizing profile 434 and/or user provided vaporizer cartridge vaporizing profile 436 may be communicated to the controller of the vaporizer device body 204 utilizing the communication interface 440. The controller in the vaporizer device body 204 may then communicate with the regulator 452 to control a temperature of the heating element 412 in accordance with a portion of the default vaporizer cartridge vaporizing profile 434 and/or the user provided vaporizer cartridge vaporizing profile 436.

The power interface 416 may be coupled to a power source in the vaporizer device body 204 and may provide power to the memory 424, regulator 452, heating element 412, and/or other components included in the vaporizer cartridge 404. The vaporizer cartridge 404 may also include a charge storage unit 472, such as but not limited to a battery or capacitor, which may be utilized to store energy when the vaporizer cartridge 404 is not coupled to the vaporizer device body 204. The reservoir 408 of the vaporizer cartridge 404 may include a reservoir sensor 444 that senses various characteristics of the reservoir 408 and/or heating element 412. For instance, the reservoir sensor 444 may sense an actual temperature of the heating element 412, an amount of substance to be vaporized remaining in the reservoir 408, an airflow flow rate through the heating element 412 or flowing by the heating element 412. Of course, the reservoir sensor 444 may sense other characteristics of the reservoir 408.

The vaporizer cartridge 404 may additionally include a sensor 468. The sensor 468 may sense one or more characteristics of the vaporizer cartridge 404. As one non-limiting example, the sensor 468 may sense or otherwise determine an airflow rate occurring between the heating element 412 and the mouthpiece 216. As another non-limiting example, the sensor 468 may sense a temperature within the vaporizer cartridge 404, a power status of the power interface 416, a communication status of the communication interface 440, a pressure drop or increase indicating whether a draw or puff event starts or stops, and whether the vaporizer cartridge 404 is inserted into the vaporizer device body 204. Moreover, the sensor 468 may work in conjunction with an airflow controller to control an amount of airflow provided to the heating element 412 and/or the mouthpiece 216. Information from the sensor 468 may be used to determine a dosage. Dosage information may also be calculated, measured, estimated, or determined based on information from other sensors such as the reservoir sensor 444. Dosage may be determined on a per draw or puff event or for the duration of a session for a user. For example, an amount of vapor generated and/or consumed during a single puff or draw may be determined. The number of puffs or draws may similarly be counted. A strength or other quality of the substance being vaporized may also be quantified and used in the dosage analysis. Dosage may be measured in terms of milligrams or other units.

In accordance with at least one embodiment of the present disclosure, the vaporizer cartridge 404 may include a status/display indicator 448 which displays a status and/or selection of one or modes of operation. For example, the status/display indicator 448 may display a currently selected default vaporizer cartridge vaporizing profile 434 or user provided vaporizer cartridge vaporizing profile 436. The status/display indicator 448 may include one or more light-emitting-diodes and/or an LCD screen. The vaporizer cartridge 404 may also include a user input receiving device 456 for providing input to the vaporizer cartridge 404. For example, the vaporizer cartridge 404 may be utilized to select a mode of operation and/or one or more of the default vaporizer cartridge vaporizing profile 434 and/or user provided vaporizer cartridge vaporizing profile 436. The vaporizer cartridge 404 may include a processor 460 for processing information provided from one or more components previously described. In accordance with at least one embodiment of the present disclosure, the inclusion of the processor 460 may adapt the vaporizer cartridge 404 such that the vaporizer cartridge 404 requires only power at the power interface 416 to operate. The communication interface 440 may communicate wirelessly to the vaporizer device body 204 and/or the application, or app, 128 executing on the communication device 108 utilizing the wireless communication antenna 464. One or more components of the vaporizer cartridge 404 may communicate with or receive power from another of the components of the vaporizer cartridge 404 utilizing the bus 420.

In some embodiments, a vaporizer cartridge 404 may include a haptic feedback system 476 to apply force, vibration, or motion to a user as feedback. The haptic feedback system 476 may include one or more of an eccentric rotating mass actuator, a linear resonant actuator, piezoelectric actuators, and/or other means to produce vibrations.

Feedback via the haptic feedback system 476 may be used in a variety of ways to allow the vaporizer cartridge 404, vaporizer device body, or communication device 108 to communicate with a user of the vaporizer. For example, the haptic feedback system 476 may be used to alert a user when a certain dosage has been reached, when the vaporizer cartridge 404 has connected to a communication device 108, when a battery of the vaporizer is low, or upon the occurrence of other events. The haptic feedback system 476 may also be used to improve the user experience of a user interacting with the device. For example, the haptic feedback system 476 may provide vibratory feedback when a user makes contact with the device or with one or more buttons on the device. In accordance with at least one embodiment of the present disclosure, the user input receiving device 456 for providing input to the vaporizer cartridge 404 may include one or more buttons or other user input devices. For example, the user input receiving device 456 may comprise a four-way toggle button allowing a user to make selections relevant to the vaporizer cartridge 404.

In accordance with at least one embodiment of the present disclosure, the vaporizer cartridge 404 may include one or more accelerometers or gyroscopic sensors 480. The accelerometers or gyroscopic sensors 480 may be used to gather information relating to usage of the vaporizer, for example a user lifting the vaporizer, setting down the vaporizer, and other events may be logged in memory of the vaporizer cartridge 404 or in memory of the vaporizer device body, discussed below, or by the application of the communication device 108.

In addition, the accelerometers or gyroscopic sensors 480 may be used to signal the vaporizer device 104 to communicate with the communication device 108 indicating the user has picked up the device 104. This, in turn, can initiate communication with the user via the API. Such communications include but are not limited to social media or marketing messages from cartridge vendors, for example, coupons for future purchases may be presented on the communication device 108. In some embodiments, data from the accelerometers or gyroscopic sensors 480 may be used to begin a pairing process between the vaporizer device 104 and a communication device 108. Additionally, or alternatively, data from the accelerometers or gyroscopic sensors 480 may be used to queue an automated portal executing on a communication device 108 to send one or more notifications to the user, for example relating to product promotions, information relating to nearby stores and/or dispensaries, and/or food notifications may be pushed through a customer rewards portal (e.g. pizza coupons, offers for restaurant deals, etc.).

In accordance with at least one embodiment of the present disclosure, the vaporizer cartridge 404 may include one or more speakers 484. Speakers 484 may be used to provide feedback to a user of the vaporizer. For example, speakers 484 may be used to alert a user when a certain dosage has been reached, when the vaporizer cartridge 404 has connected to a communication device 108, when a battery of the vaporizer is low, or upon the occurrence of other events. The speakers 484 may also be used to improve the user experience of a user interacting with the device. For example, the speakers 484 may provide auditory feedback when a user makes contact with the device or with one or more buttons on the device.

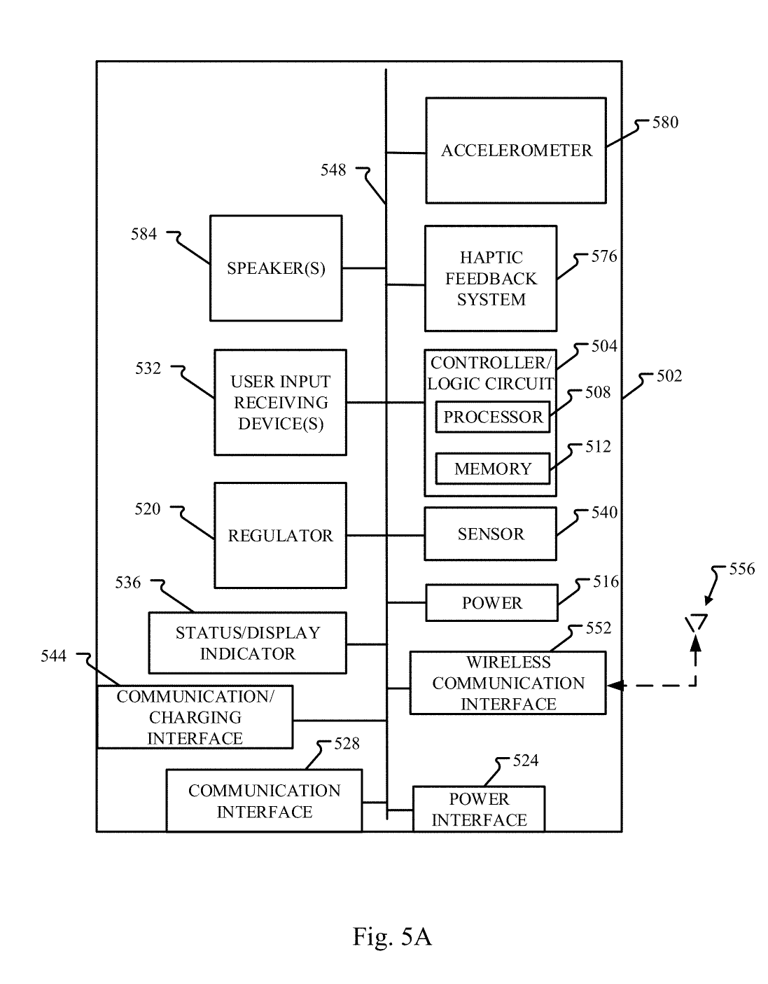

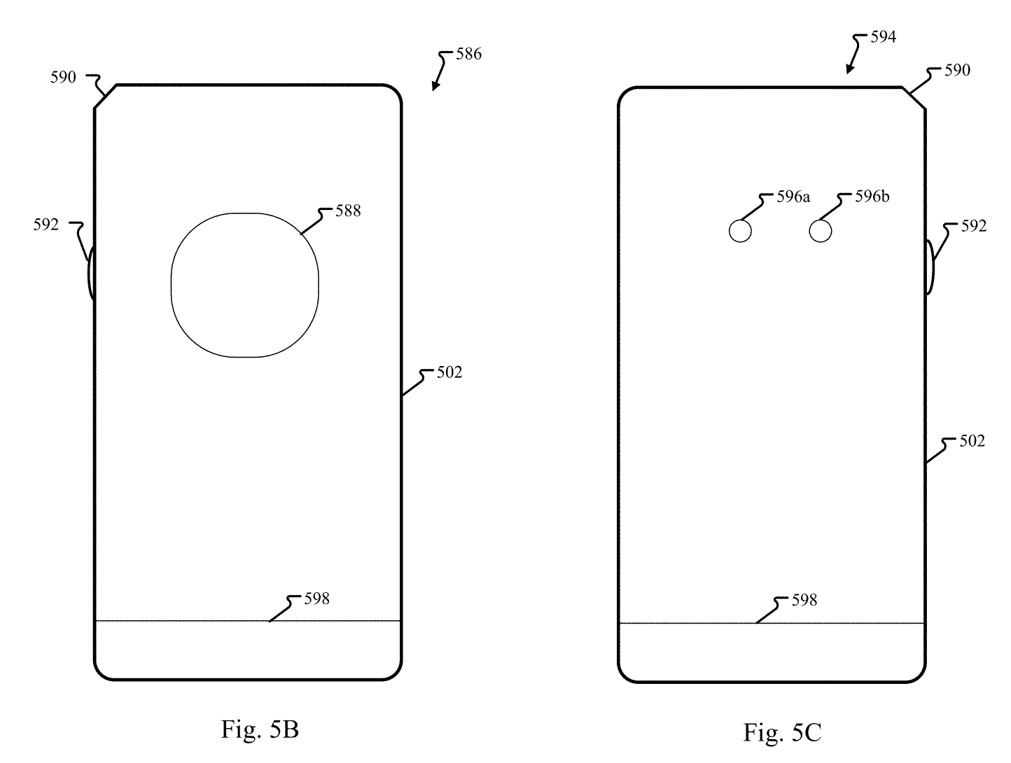

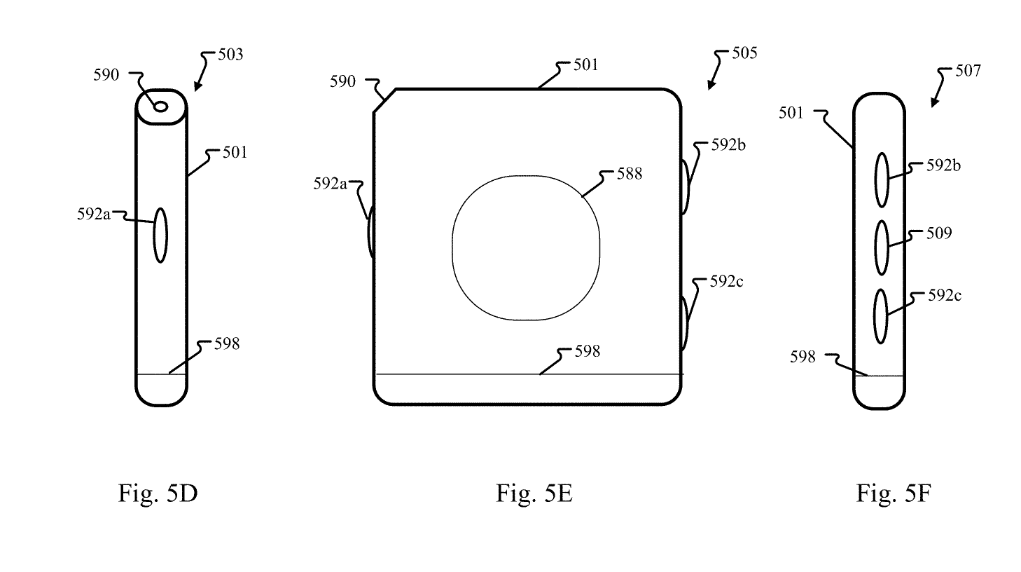

FIG. 5A depicts a vaporizer device body 502 in accordance with at least one embodiment of the present disclosure. The vaporizer device body 502 may be the same as or similar to the vaporizer cartridge 404 as previously described. The vaporizer device body 502 may include a controller/logic circuit 504. The controller/logic circuit 504 may include a processor 508 and/or memory 512. The processor 508 may be capable of executing program instructions. The processor 508 may include any general-purpose programmable processor or controller for executing application programming. Alternatively, or in addition, the processor 508 may comprise an application specific integrated circuit (ASIC). The processor 508 generally functions to execute programming code that implements various functions performed by the vaporizer device body 502. The processor 508 of one or more of the vaporizer device bodies 502 may operate to execute one or more computer-executable instructions of one or more of the functions of the vaporizer device body 502 and/or associated with the communications to the application, or app, 128 executing on the communication device 108.

The controller/logic circuit 504 additionally includes memory 512. The memory 512 may be used in connection with the execution of programming instructions by the controller/logic circuit 504 and for the temporary or long-term storage of data and/or program instructions. The memory 512 may comprise solid-state memory that is resident, removable, and/or remote in nature, such as DRAM and SDRAM. Moreover, the memory 512 may include a plurality of discrete components of different types and/or a plurality of logical partitions. In accordance with still other embodiments, the memory 512 comprises a non-transitory computer-readable storage medium. Such a medium may take many forms, including, but not limited to, non-volatile media, volatile media, and transmission media.

The vaporizer device body 502 may provide power from the power source 516 to the vaporizer cartridge 404 utilizing the power interface 524. That is, the power interface 524 of the vaporizer device body 502 may be communicatively coupled to the power interface 416 of the vaporizer cartridge 404 when the vaporizer cartridge 404 is inserted into the vaporizer device body 502. The power source 516 may be any type of electrical storage unit. Non-limiting examples of the power source 516 include one or more batteries and/or one or more capacitors. The controller/logic circuit 504 may communicate with one or more components of the vaporizer cartridge 404 utilizing the communication interface 528. That is, the communication interface 528 of the vaporizer device body 502 may be communicatively coupled to the communication interface 440 of the vaporizer cartridge 404 when the vaporizer cartridge 404 is inserted into the vaporizer device body 502. In some embodiments, the communication interface 528 may comprise a wired connection, for example a USB 2.0, 3.0, 3.1, 3.2, or 4 connection of Type A, B, or C.

In accordance with at least one embodiment of the present disclosure, the vaporizer device body 502 may include a regulator 520 for regulating a temperature of the heating element 412 of the vaporizer cartridge 404. Thus, the controller/logic circuit 504 may communicate with or otherwise control the regulator 520 such that the regulator 520 provides and/or alters a current, voltage, and/or amount of power in accordance with an instruction from the controller/logic circuit 504. The regulator 520 may be communicatively coupled with the power interface 416 through the communication interface 528 and the communication interface 440. The vaporizer device body 502 may further include a wireless communication interface 552 and wireless communication interface antenna 556 for communicating with the application, or app, 128 executing on the communication device 108. Thus, the controller/logic circuit 504 may receive information and data from the application, or app, 128 executing on the communication device 108 and store such information in the memory 512. The vaporizer device body 502 may further include a communication/charging interface 544; the communication/charging interface 544 provides an interface for wired connections and power. Thus, the communication device 108 may communicate with the vaporizer device body 502 utilizing the communication/charging interface 544. Moreover, the power source 516 may be charged through the communication/charging interface 544.

The vaporizer device body 502 may include a status/display indicator 536 and/or user input receiving device 532. The status/display indicator 536 may display or otherwise indicate a status of, or mode of operation of, the vaporizer device body 502, vaporizer cartridge 404, and/or the vaporizer device 104 as a whole. More specifically, the status/display indicator 536 may indicate whether the vaporizer device 104 is in an app connection state, utilizing a default vaporizer cartridge vaporizing profile 434, utilizing a user provided vaporizer cartridge vaporizing profile 436, or utilizing a single temperature or single output setting. The user input receiving device 532 may receive input from a user to change an operational mode of the vaporizer device body 502, the vaporizer cartridge 404, and/or the vaporizer device 104. For example, a user may utilize the user input receiving device 532 to select a specific vaporizer cartridge vaporizing profile 220. As another example, a user may utilize the user input receiving device 532 to select whether the vaporizer device 104 is in an app connection state, utilizing a default vaporizer cartridge vaporizing profile 434, utilizing a user provided vaporizer cartridge vaporizing profile 436, or utilizing a single temperature or single output setting. The user input receiving device 532 and the status/display indicator 536 may work together, be coupled together, or otherwise be included as a single element, such as a touchscreen interface and/or as an illuminated selector.

The vaporizer device body 502 may utilize one or more sensors 540. The sensor 540 may sense one or more characteristics of the vaporizer device body 502. As one non-limiting example, the one or more sensors 502 may sense or otherwise determine an airflow rate occurring within the vaporizer device body 502 between the vaporizer cartridge 404 and the mouthpiece 216. As another non-limiting example, the one or more sensors 540 may sense a power status of the power interface 524, a power status of the power source 516, a communication status of the communication interface 528, a pressure drop or increase within the vaporizer device body 502 indicating whether a draw or puff event starts or stops, and whether the vaporizer cartridge 404 is inserted into the vaporizer device body 502. Moreover, the one or more sensors 540 may work in conjunction with an airflow controller to control an amount of airflow provided to the heating element 412 of the vaporizer cartridge 404 and/or the mouthpiece 216.

In some embodiments, a vaporizer device body 502 may include a haptic feedback system 576 to apply force, vibration, or motion to a user as feedback. The haptic feedback system 576 may include one or more of an eccentric rotating mass actuator, a linear resonant actuator, piezoelectric actuators, and/or other means to produce vibrations. Feedback via the haptic feedback system 576 may be used in a variety of ways to allow the vaporizer device body 502, vaporizer device body, or communication device 108 to communicate with a user of the vaporizer. For example, the haptic feedback system 576 may be used to alert a user when a certain dosage has been reached, when the vaporizer device body 502 has connected to a communication device 108, when a battery of the vaporizer is low, or upon the occurrence of other events. The haptic feedback system 576 may also be used to improve the user experience of a user interacting with the device. For example, the haptic feedback system 576 may provide vibratory feedback when a user makes contact with the device or with one or more buttons on the device.

In accordance with at least one embodiment of the present disclosure, the user input receiving device 556 for providing input to the vaporizer device body 502 may include one or more buttons or other user input devices. For example, the user input receiving device 556 may comprise a four-way toggle button allowing a user to make selections with the vaporizer device body 502. In some embodiments, the vaporizer device body 502 may further include a button on a side of the device body 502 which may act as a selector button. For example, a user may use a four-way toggle button on a back or front face of the device body 502 to identify one of a number of options and a side button may be used to select the option identified using the four-way toggle button.

In accordance with at least one embodiment of the present disclosure, the vaporizer device body 502 may include one or more accelerometers or gyroscopic sensors 580. The accelerometers or gyroscopic sensors 580 may be used to gather information relating to usage of the vaporizer, for example a user lifting the vaporizer, setting down the vaporizer, and other events may be logged in memory of the vaporizer device body 502 or in memory of the vaporizer cartridge, discussed above, or by the application of the communication device 108. For example, data from an accelerometer may be used to determine that the vaporizer device has been dormant or otherwise at rest for a duration of time. Such data may be used to set the device into a sleep or standby mode or may be used to shut down the device. Similarly, data from the accelerometer may be used to determine that the vaporizer device has moved after a period of rest. Such data may be used to determine that the device is or is about to be used by a user. Additionally, and/or in the alternative, at least one accelerometer and a gyroscopic sensor may be used to quantify relative movement, for example, vertical movement greater than a predetermined value and/or horizontal movement greater than a predetermined value. This allows the device to distinguish between types of motion, for example, motion associated with a user carrying the device and a user moving the device to his or her mouth to use the device.

Upon a determination that the device has begun to move after a period of rest, a processor of the device may begin a startup mode. Any information gained from the accelerometer about the usage and/or movement of the device may be logged in memory of the device and/or shared with one or more other devices. In some embodiments, data from an accelerometer and/or a gyroscopic sensor may be used to determine when the vaporizer is lifted or raised by a user. Such information may be used to determine that the vaporizer device will soon be used and should begin a heating process in order to vaporize material being drawn from the vaporizer device. Similarly, data from an accelerometer and/or a gyroscopic sensor may be used to determine when the vaporizer device is lowered or set down by a user. Such information may be used to determine that the vaporizer will no longer be used for a period of time and may cease heating elements within the device.

In accordance with at least one embodiment of the present disclosure, the vaporizer device body 502 may include one or more speakers 584. Speakers 584 may be used to provide feedback to a user of the vaporizer. For example, speakers 584 may be used to alert a user when a certain dosage has been reached, when the vaporizer device body 502 has connected to a communication device 108, when a battery of the vaporizer is low, or upon the occurrence of other events. The speakers 584 may also be used to improve the user experience of a user interacting with the device. For example, the speakers 584 may provide auditory feedback when a user makes contact with the device or with one or more buttons on the device. FIG. 5B depicts a first face of an external view 586 of a vaporizer device body 502 in accordance with embodiments of the present disclosure. The vaporizer device body 502 may include a mouthpiece portion 590 including a hole for vapors to be drawn from the device body 502. For example, the mouthpiece portion 590 may comprise a hole on a side, edge, corner, front face, back face, top, bottom, or other portion of the vaporizer device body 502. The vaporizer device body 502 may also include a side button 592 and/or a four-way toggle button 588.

The four-way toggle button 588 may be a cover piece covering one or more actuator buttons, for example a user may set his or her thumb on the toggle button 588 and may be capable of selecting between 2, 4, 8, or any other number of choices. In some embodiments, to make an input on the device, the user may effectively point the toggle button 588 in a direction of a choice and may then press a side button 592 to lock in the selection. The device may then provide feedback for example using LED lights, sounds from speakers, haptic feedback from a haptic feedback system, user interface display on a communication device, a combination of the above, or any other means of providing feedback. For example, as a user interacts with buttons on the vaporizer device body 502, a user interface of a communication device may display a graphical user interface showing options being selected by the user interacting with the device. Alternatively, or additionally, feedback guiding a user interacting with the device may be provided through LED lights. For example, lights may turn on and off and/or may change colors to illustrate to a user interacting with the device as to which options are being selected from which options are being selected.

The vaporizer device body 502 may also include a cartridge compartment 598 allowing for access to slots in the device body 502 in which cartridges may be inserted. For example, the vaporizer device body 502 may include a compartment door with a hinge allowing for one or more slots to be accessed so that one or more cartridges may be inserted into the vaporizer device body 502. In some embodiments, a cartridge may be shaped in such a way as a portion of the cartridge is visible and extends from the device body 502. For example, the cartridge compartment 598 may be a portion of a cartridge inserted into the device body 502.

FIG. 5C depicts a second face of an external view 594 of a vaporizer device body 502 in accordance with embodiments of the present disclosure. As can be appreciated from the illustration, the mouthpiece portion 590 may extend onto the second face and the side button 592 may also be accessible from the second face. The cartridge compartment 598 may also be accessible from the second face or one of the first and second faces may include a back side of a compartment door of the cartridge compartment 598 while the other of the first and second faces includes a front side of the compartment door. The second face of the vaporizer device body 502 may include one or more LEDs 596a, 596b or other indicators which may be used to communicate with a user of the device. LEDs 596a, 596b may be used in place of or in addition to other systems for providing feedback and may be used to provide information to a user of the device such as battery level, dosage amounts, cartridge information, communication device pairing information, or other information. In some embodiments, the external surface of the vaporizer device body 502 may include one or more holes for speakers to emit sound.

As illustrated in FIGS. 5D-5F, a vaporizer body 501 may comprise a generally square shape. Such a vaporizer body 501 may include a cartridge compartment 598 which may allow for one or more cartridges to be inserted into the body 501. A first side 503 of the vaporizer body 501 may include one or more side buttons 592a as illustrated in FIG. 5D. A corner of the vaporizer body 501 may include a mouthpiece 590 for drawing vapors from the vaporizer body 501. While the mouthpiece 590 is illustrated in a corner of the vaporizer body 501, it should be appreciated that the mouthpiece 590 may be at any other point on the vaporizer body 501.

A front face 505 of the vaporizer body 501 may include a toggle button 588 such as that described above and illustrated in FIG. 5B. Side buttons 592a-c may project from the sides of the vaporizer device 501 such that the buttons may be visible when the device is viewed from the front as illustrated in FIG. 5E. In some embodiments, however, one or more of the side buttons 592a-c may be recessed. The front face 505 of the vaporizer body 501 may include a hinged cartridge compartment 598 which may be opened to allow one or more cartridges to be inserted into the vaporizer body 501. The mouthpiece portion 590 of the vaporizer body 501 may be a beveled, chamfered, or otherwise shaped corner of the vaporizer body 501 and may comprise a hole through which vapor may travel out of the vaporizer body 501.

A second side 507 of the vaporizer body 501 may include one or more side buttons 592b, 592c, and may include a USB port 509 which may be used to one or more of charge the vaporizer body 505 and/or any inserted cartridges and provide data communication between the vaporizer body 501 and another device such as a computing system.

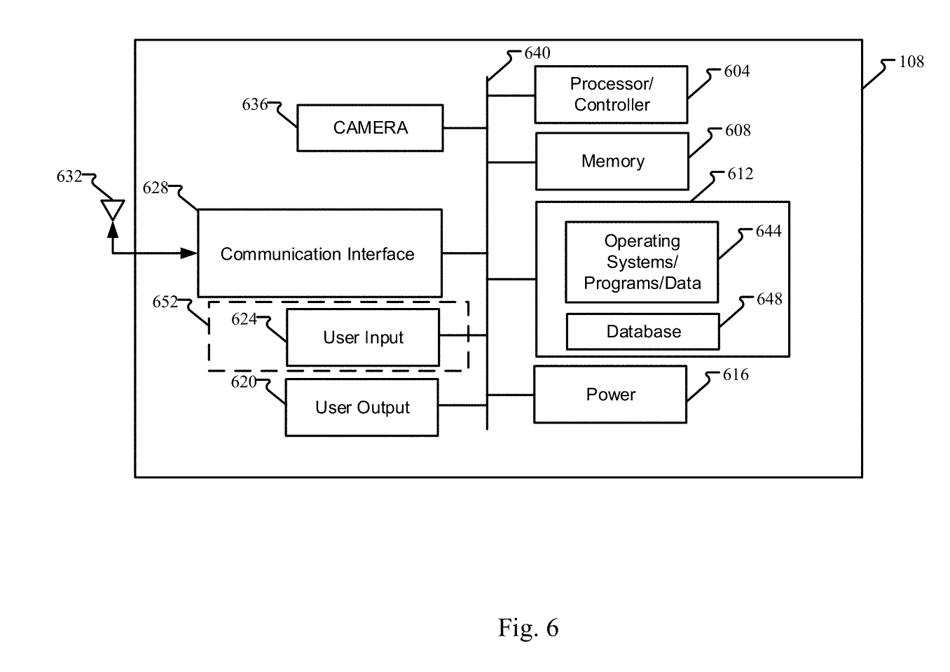

FIG. 6 depicts an example communication device 108 in accordance with embodiments of the present disclosure. The communication device 108 may include a processor/controller 604 capable of executing program instructions. The processor/controller 604 may include any general-purpose programmable processor or controller for executing application programming. Alternatively, or in addition, the processor/controller 604 may comprise an application specific integrated circuit (ASIC). The processor/controller 604 generally functions to execute programming code that implements various functions performed by the communication device 108. The processor/controller 604 of the communication device 108 may operate to execute one or more computer-executable instructions of the application, or app, 128 executing on the communication device 108. Alternatively, or in addition, the processor/controller 604 may operate to execute one or more computer-executable instructions of one or more services and/or one or more functions associated with the vaporizer device 104.

The communication device 108 additionally includes memory 608. The memory 608 may be used in connection with the execution of programming instructions by the processor/controller 604, and for the temporary or long-term storage of data and/or program instructions. The memory 608 may comprise solid-state memory that is resident, removable, and/or remote in nature, such as DRAM and SDRAM. Moreover, the memory 608 may include a plurality of discrete components of different types and/or a plurality of logical partitions. In accordance with still other embodiments, the memory comprises a non-transitory computer-readable storage medium. Such a medium may take many forms, including, but not limited to, non-volatile media, volatile media, and transmission media.

The communication device 108 may include storage 612 for storing an operating system, one or more programs 644, and additional data in the database 648. The storage 612 may be the same as or different from the memory 608. For example, the storage 612 of the communication device 108 may include the database 648 for storing data used by the communication device 108 and/or the application, or app, 128 executing on the communication device 108.

In addition, user input devices 624 and user output devices 620 may be provided and used in connection with the communication device 108. For example, a user 120 may adjust one or more temperature points of a vaporizer cartridge vaporizing profile 220 utilizing a touchscreen display comprising the user input device 624 and/or the user output device 620. Non-limiting examples of user input devices 624 include a keyboard, a numeric keypad, a microphone, scanner, and pointing device combined with a screen or other position encoder. Non-limiting examples of user output devices 620 include a display, a touch screen display, a speaker, and a printer. Further, the user output devices 620 may provide, or otherwise render, one or more interfaces for user interfacing.

The communication device 108 generally includes a communication interface 628 to allow for communication between communication devices, such as communication devices 108, the crowd sourced data platform 132, and the vaporizer device 104. The communication interface 628 may support 3G, 4G, cellular, WiFi, Bluetooth®, NFC, RS232, RF, Ethernet, one or more communication protocols, and the like. In some instances, the communication interface 628 may be connected with an antenna 632. Alternatively, or in addition, the communication interface 628 may be connected to one or more mediums for accessing the communication network 116.

The communication device 108 may include at least one imaging device, such as a camera 636. The camera 636 may allow a user 120 of the communication device 108 to capture images, such as a QR image used in a validation procedure as previously discussed and further as will be discussed. Communications between various components of the communication device 108 may be carried by one or more buses 640. Moreover, power 616 can be supplied to the components of the communication device 108. The power 616 may, for example, include a battery, an AC to DC converter, power control logic, and/or ports for interconnecting the communication device 108 to an external source of power.

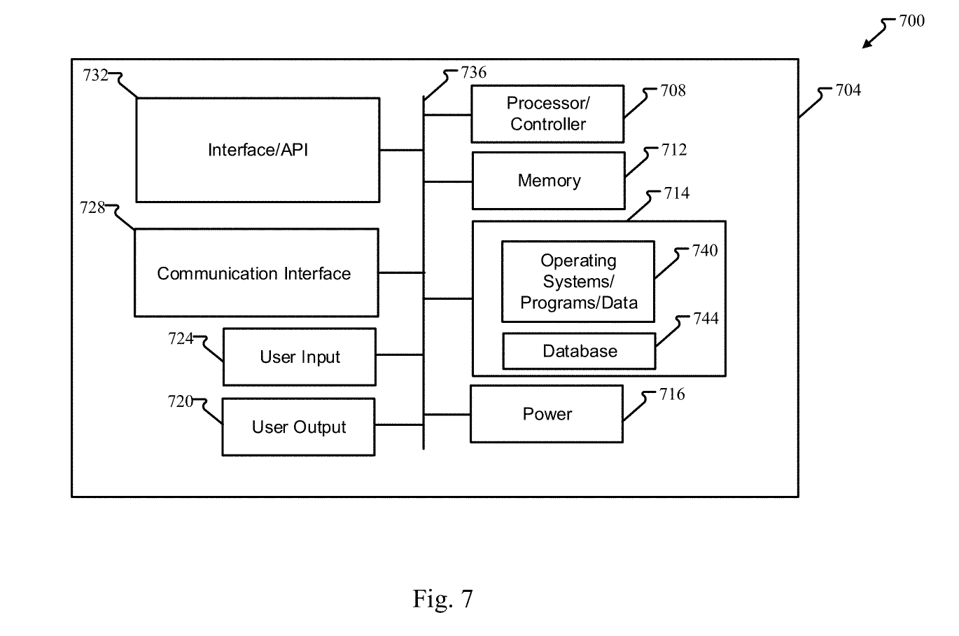

FIG. 7 depicts additional details of one or more servers 704 implementing the crowd sourced data platform 132 in accordance with embodiments of the present disclosure. The server 704 may be the same as or similar to the one or more application/data servers 144 as previously described. Similar to the communication device 108, the server 704 may include one or more processor/controllers 708 capable of executing program instructions. A processor/controller 708 may be the same as or similar to the processor/controller 604, and therefore may include any general-purpose programmable processor or controller for executing application programming. Alternatively, or in addition, the processor/controller 708 may comprise an application specific integrated circuit (ASIC). The processor/controller 708 generally functions to execute programming code that implements various functions performed by the server 704 and the crowd sourced data platform 132. The processor/controller 708 of one or more of the servers 704 may operate to execute one or more computer-executable instructions of the crowd sourced data platform 132 as will be described herein. Alternatively, or in addition, the processor/controller 708 of one or more of the crowd sourced data platform 132 may operate to execute one or more computer-executable instructions of one or more services module 140 and/or one or more functions associated with the data and database 136.

The server 704 additionally includes memory 712. The memory 712 may be used in connection with the execution of programming instructions by the processor/controller 708, and for the temporary or long-term storage of data and/or program instructions. For example, the processor/controller 708, in conjunction with the memory 712 of the server 704, may implement one or more modules, web services, APIs and other functionality that is needed and accessed by a communication device, such as communication device 108. The memory 712 of the server 704 may comprise solid-state memory that is resident, removable, and/or remote in nature, such as DRAM and SDRAM. Moreover, the memory 712 may include a plurality of discrete components of different types and/or a plurality of logical partitions. In accordance with still other embodiments, the memory comprises a non-transitory computer-readable storage medium. Such a medium may take many forms, including, but not limited to, non-volatile media, volatile media, and transmission media.

The server 704 may include storage 714 for storing an operating system, one or more programs, and additional data. The storage 714 may be the same as or different from the memory 712. For example, the storage 714 of the server 704 may include a database 744 for storing data. Of course, the database 744 may be distributed across one or more servers 704.

In addition, user input devices 724 and user output devices 720 may be provided and used in connection with the server 704. Alternatively, or in addition, a first user may enter information, or initiate a communication with the crowd sourced data platform 132, by directing a web browser to a website served and/or provided by the server 704 by entering a website address or by clicking on a hyperlink associated with the website. Alternatively, or in addition, a user may enter information, or initiate a communication with the crowd sourced data platform 132, by interacting with a mobile application, such as the application, or app, 128 executing on the communication device 108. Otherwise, a user may interact with the server 704 using user input devices 724 and user output devices 720. Non-limiting examples of user input devices 724 include a keyboard, a numeric keypad, a touch screen, a microphone, scanner, and pointing device combined with a screen or other position encoder. Non-limiting examples of user output devices 720 include a display, a touch screen display, a speaker, and a printer. Further, user output devices 720 may provide one or more interfaces for user interfacing.

The server 704 generally includes a communication interface 728 to allow for communication between communication devices, such as communication devices 108, and the crowd sourced data platform 132. The communication interface 728 may support 3G, 4G, cellular, WiFi, Bluetooth®, NFC, RS232, RF, Ethernet, one or more communication protocols, and the like. In some instances, the communication interface 728 may be connected to one or more mediums for accessing the communication network 116.

The server 704 may include an interface/API 732. Such interface/API 732 may include the necessary functionality to implement the crowd sourced data platform 132 or a portion thereof. Alternatively, or in addition, the interface/API 732 may include the necessary functionality to implement one or more services and/or one or more functions related to the data. Alternatively, or in addition, the interface/API 732 may include the necessary functionality to implement one or more of the crowd sourced data platform 132, application, or app, 128 executing on the communication device 108, messaging application 308, and/or third-party access applications 312 and/or portions thereof. Communications between various components of the server 704 may be carried by one or more buses 736. Moreover, power 716 can be supplied to the components of the server 704. The power 716 may, for example, include a battery, an AC to DC converter, power control logic, and/or ports for interconnecting the server 704 to an external source of power.

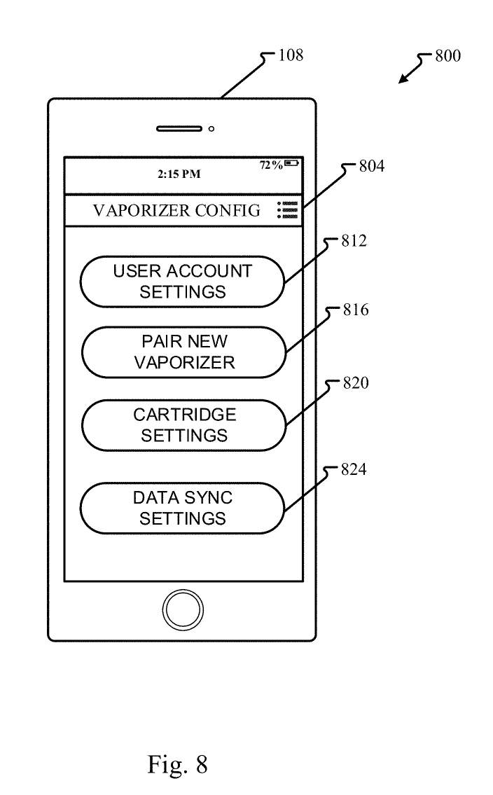

FIG. 8 depicts a first user interface 800 of the application, or app, 128 executing on the communication device 108 in accordance with at least one embodiment of the present disclosure. The first user interface 800 may display an initial rendering or display to a user such that the user can select or configure the application, or app, 128 executing on the communication device 108 and/or configure the vaporizer device 104. For example, a vaporizer configuration menu 804 including user account settings 812, an option to pair a new vaporizer 816, an option to configure cartridge settings 820, and an option to configure data sync settings 824 may be presented to the user. Of course, more or less options may be presented to the user in the vaporizer configuration menu 804. As will be described, the user account settings 812 option provides a means for a user to add and/or change details associated with the user profile 124; the pair new vaporizer 816 provides a means for allowing a user to add a new vaporizer device and/or manage existing vaporizer devices; the cartridge settings 820 option allows a user to add a new vaporizer cartridge and/or manage existing vaporizer cartridges; and the data sync settings 824 option provides a means for allowing a user to add and/or manage selected data and a frequency at which the selected data from the application, or app, 128 executing on the communication device 108 and/or vaporizer device 104 is synchronized to the crowd sourced data platform 132.

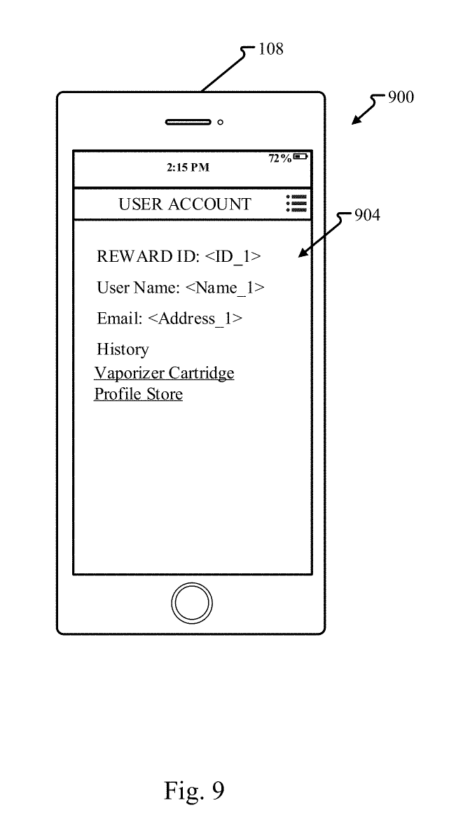

FIG. 9 depicts a second user interface 900 of the application, or app, 128 executing on the communication device 108 in accordance with at least one embodiment of the present disclosure. The second user interface 900 depicts user account details 904 associated with one or more user profiles 124. The user account details 904 may include a reward identifier, such as a unique identifier associated with a user 120; a user name associated with the user 120, personal details such as an email address, or other information, associated with the user 120, and history information. The history information may include a purchase history, a device use history, a cartridge use history, and/or a vaporizer cartridge vaporizing profile 220 use history. In accordance with at least one embodiment of the present disclosure, the user account details 904 may provide information related to a vaporizer cartridge vaporizing profile store. The information related to the vaporizer cartridge vaporizing profile store may include vaporizer cartridge vaporizing profiles in which the user has purchased advertisements and/or messages directed to one or more vaporizer cartridge vaporizing profiles.

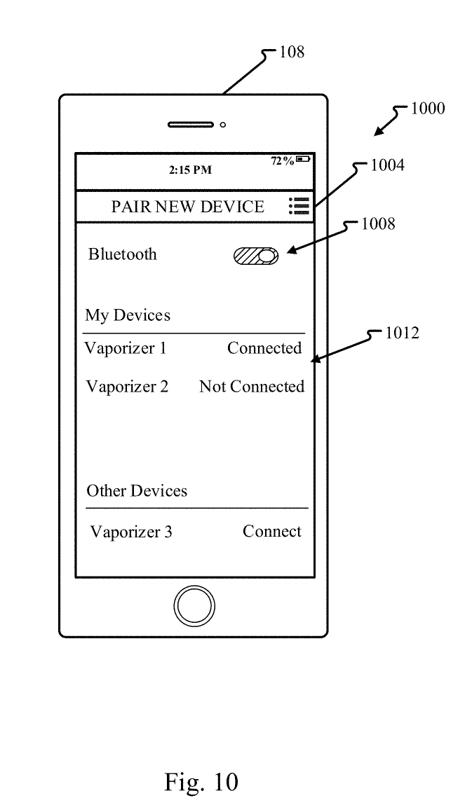

FIG. 10 depicts details of a third user interface 1000 in accordance with at least one embodiment of the present disclosure. The third user interface 1000 may allow a user 120 to add a vaporizer device 104 and/or modify one or more configuration settings associated with a previously paired vaporizer device 104. Accordingly, the paring menu 1004 may allow a user to turn on or off a Bluetooth® pairing capability utilizing the Bluetooth® slider 1008. Moreover, the paired vaporizer devices 1012 area may depict those vaporizer devices which have been paired to the communication device 108 and/or which vaporizer device may be currently connected. Lastly, the paring menu 1004 may display other vaporizer devices which may not be currently paired with the communication device 108 but may be available for pairing.

A trusted relationship may be established between the vaporizer device 104 using a numerical password, commonly referred to as a passkey. Depending on how often the vaporizer device 104 connects to the communication device 108, the user 120 might opt to have the passkey saved for future connection attempts or prompted to enter the passkey each time the vaporizer device 104 requests communication with the communication device 108 or the communication device 108 requests communication with the vaporizer device 104. The passkey may be a four-digit number supplied at the time the trusted relationship between the vaporizer device 104 and the communication device 108 is established. When the passkey is verified on either one of the vaporizer device 104 and/or the communication device 108, the two have been paired. The Bluetooth® device and passkey information may be stored so future pairing attempts do not have to be made unless desired as a security precaution. In addition to the previously described passkey entry association model, other Bluetooth® paring options that may be utilized including, but are not limited to, the numeric comparison association model, the just works association mode, and the out of band (OOB) association model. Of course, if a pairing and communication model other than Bluetooth® is utilized, other association models and pairing procedures may be used.

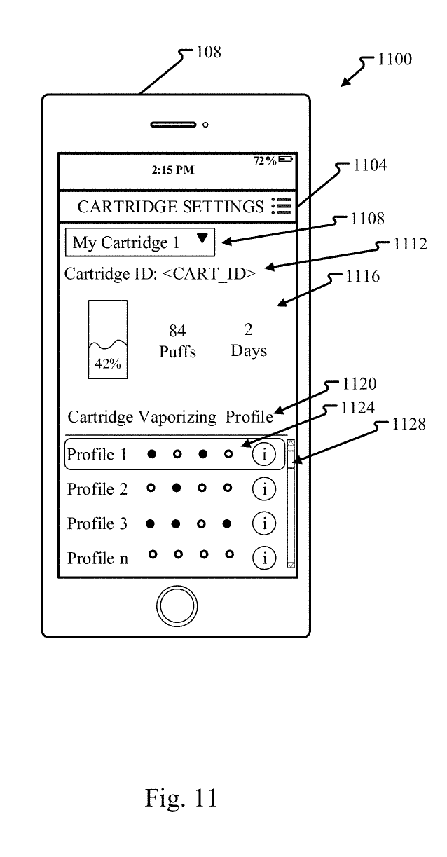

FIG. 11 depicts additional details of a fourth user interface model 1100 in accordance with at least one embodiment of the present disclosure. More specifically, the fourth user interface model 1100 may display the cartridge settings menu 1104 which includes data and configuration settings associated with a vaporizer cartridge 404. Accordingly, a user may make a cartridge selection 1108 such that cartridge identification information 1112 is displayed. The cartridge identification information 1112 may automatically be pulled from the vaporizer cartridge 404 when the vaporizer cartridge 404 is inserted into the vaporizer device body 502 and the vaporizer device 104 is synchronized with the application, or app, 128 executing on the communication device 108. In some instances, the cartridge settings menu 1104 may display cartridge information 1116. The cartridge information 1116 may include an estimated, or actual, vaporizing substance level that remains in the reservoir 408, an estimated number of puffs remaining, and an indication as to when the vaporizer cartridge 404 was last synchronized with the application, or app, 128 executing on the communication device 108 and/or the crowd sourced data platform 132.

The paring menu 1004 may include cartridge vaporizing profile 1120 information. The cartridge vaporizing profile 1120 may indicate which, if any, cartridge vaporizing profiles 1120 corresponding to a vaporizer cartridge vaporizing profile reside at the vaporizer cartridge 404. More specifically, the cartridge vaporizing profile 1120 information may indicate whether a selected profile 1124 resides in the memory 424 of the vaporizer cartridge 404. For example, a first indicator in the selected profile 1124 may indicate whether such profile is located within the memory 424 of the vaporizer cartridge 404. A second indicator in the selected profile 1124 may indicate whether such profile is a manufacturer profile or a user profile. A third indicator in the selected profile 1124 may indicate a color, indication pattern, or otherwise to be displayed at one of the status/display indicator 536 and/or status/display indicator 448. A fourth indicator in the selected profile 1124 may provide other profile information. Within the selected profile 1124, additional information or customization features may be accessed utilizing an information icon (such as the “i” icon). A scrollbar 1128 may be included such that additional profiles may be selected.

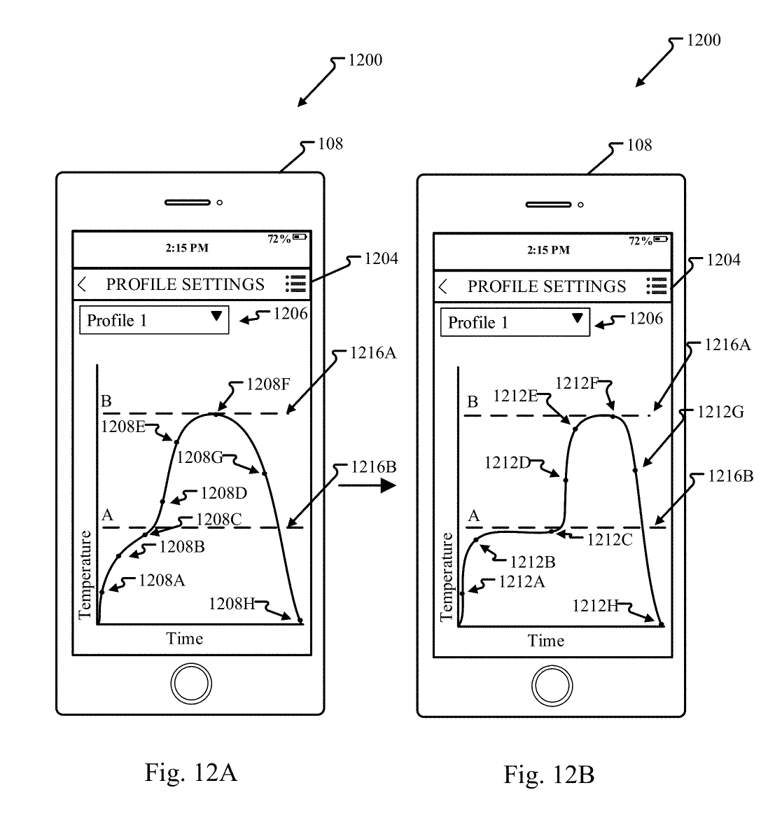

FIGS. 12A-12B depict additional details of a fifth user interface 1200 in accordance with at least one embodiment of the present disclosure. The fifth user interface 1200 depicts a profile including a menu 1204 utilized to allow a user to select a profile with the profile selector 1206 and adjust one or more temperature set points 1208A-1208H of the vaporizer cartridge vaporizing profile. Thus, a user may select a setpoint 1208B for example, and drag the set point to a desired location, such that the vaporizer cartridge vaporizing profile is adjusted. As one example, the selected setpoint 1208B is moved, resulting in a setpoint 1208B becoming associated with or otherwise located a temperature represent by setpoint 1212B. Thus, FIG. 12A depicts a vaporizer cartridge vaporizing profile prior to one or more customizations occurring, whereas FIG. 12B depicts the vaporizer cartridge vaporizing profile after one or more customizations have occurred. That is, the temperature set points 1208A-1208H of the vaporizer cartridge vaporizing profile depicted in the fifth user interface 1200 of FIG. 12A may be adjusted to resemble the temperature set points 1212A-1212H of the of the vaporizer cartridge vaporizing profile depicted in the fifth user interface 1200 of FIG. 12B. Thus, the temperature setpoints for the profile may be saved to a data structure associated with the vaporizer cartridge 404 and/or the diagnostic location 124. Also depicted in the fifth user interface 1200, indicators 1216A-1216B depicting one or more temperatures associated with characteristics of substances to be vaporized in the reservoir 408 are displayed. For example, the indicator 1216A may be associated with a temperature indicating a temperature of vaporizing for a first substance in the reservoir 408, while the indicator 1216B may be associated with a temperature indicating a temperature of vaporizing for a second substance in the reservoir 408. Such indicators 1216A-1216B may be user defined and/or may be stored or otherwise associated with the user profile 124, the vaporizer cartridge 404, and/or the vaporizer cartridge vaporizing profile 220.

The vaporizer cartridge 404 of a vaporizer device 104 may store profile information including the temperature set points and/or the indicators, settings, and other configuration data at the memory 424; accordingly, if the vaporizer cartridge 404 were inserted into a different vaporizer device, the profile information and thus the vaporizer cartridge vaporizing profile may be available to the vaporizer device in which the vaporizer cartridge 404 has been inserted.

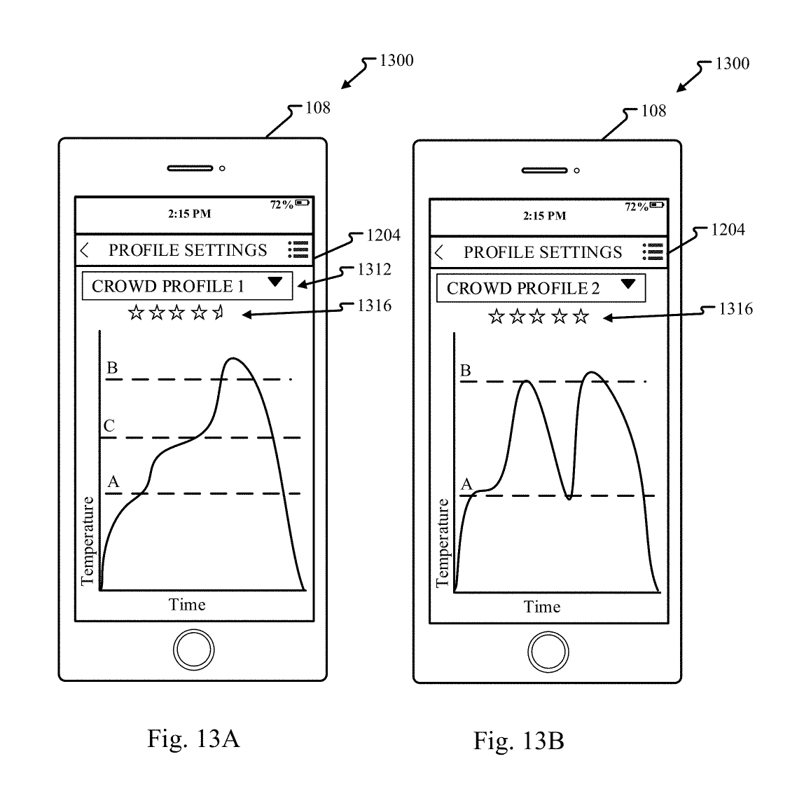

FIGS. 13A-13B depict details of a sixth user interface 1300 in accordance with at least one embodiment of the present disclosure. The sixth user interface 1300 generally depicts information that may be associated with a selected crowd sourced profile 1312. For example, a crowd sourced profile, such as the one indicated as being selected in the dropdown list 132, may include a rank or rating 1316 indicating how popular or how many users liked the specific profile. For example, the crowd sourced profile 1 may have a rating of four and one-half stars while the crowd sourced profile 2 has a rating of five stars. As each of the vaporizer cartridge vaporizing profiles may be specific to a vaporizer cartridge 404 because of the reservoir 408 contents, the profiles available to the profile menu 1204 and/or the selectable crowd sourced profiles located in the dropdown 1312 may be specific to the vaporizer cartridge 404.

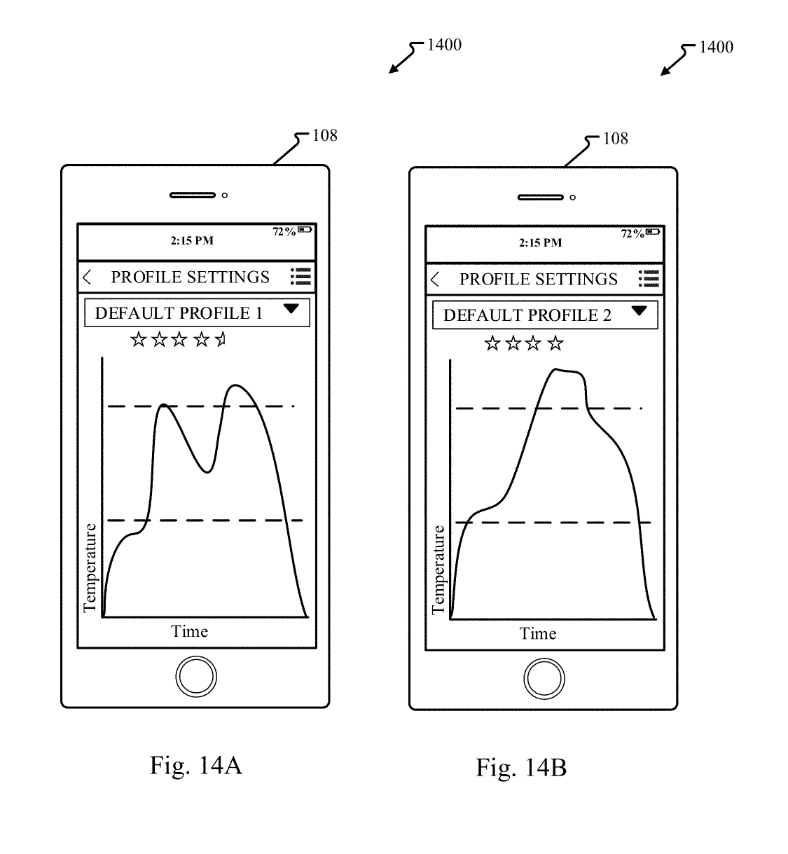

Moreover, as each vaporizer cartridge 404 includes one or more default vaporizer cartridge vaporizing profiles 434 that may be provided by a third party and/or manufacturer, information for the default vaporizer cartridge vaporizing profile 434 may be displayed to a user as illustrated with the seventh user interface 1400 of the application, or app, 128 executing on the communication device 108 displayed in FIGS. 14A-14B. That is, while a user may not be able to adjust temperature setpoints or other information associated with the default vaporizer cartridge vaporizing profile 434, the temperature setpoints may be displayable. Further, the profile rank or rating may be displayed as well.

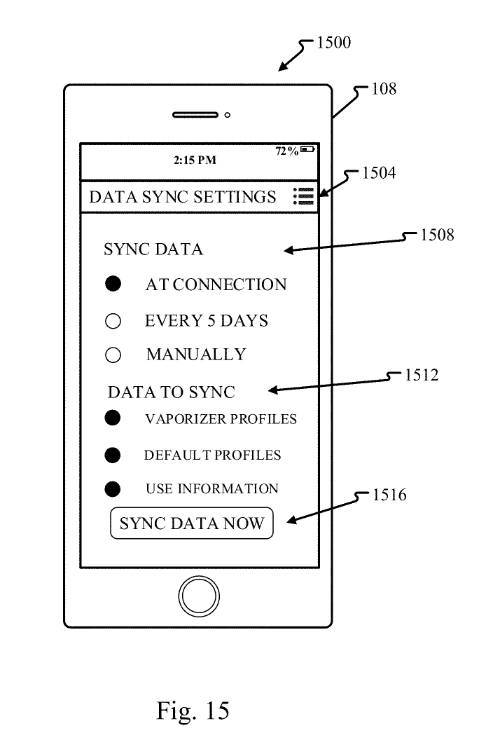

In accordance with at least one embodiment of the present disclosure, synchronization settings and configurations may be adjustable, as illustrated in FIG. 15. More specifically, a seventh user interface 1500 may illustrate a data sync settings menu 1504 where a user 120 may adjust a frequency of synchronization 1508 as well as the data to synchronize 1512. Synchronizing may occur between the vaporizer device 104 and the application, or app, 128 executing on the communication device 108 as well as between the application, or app, 128 executing on the communication device 108 and the crowd sourced data platform 132. An option 1516 to sync data instantaneously may also be presented to a user. Of course, as FIG. 15 depicts specific synchronization and data settings, it should be appreciated that other synchronization and data settings are envisioned.

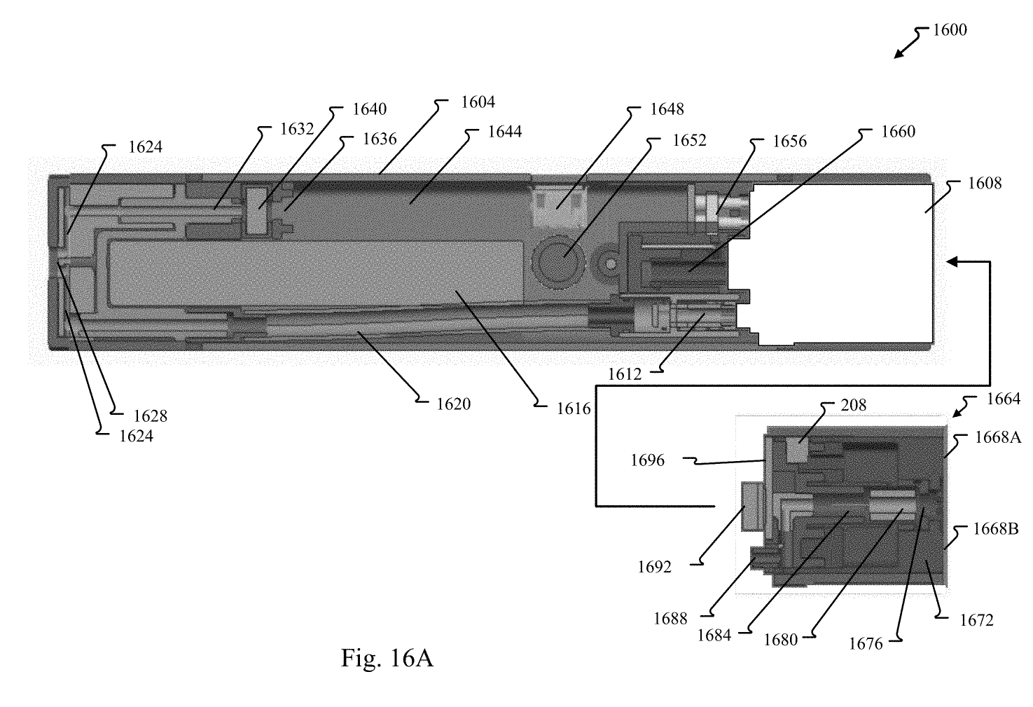

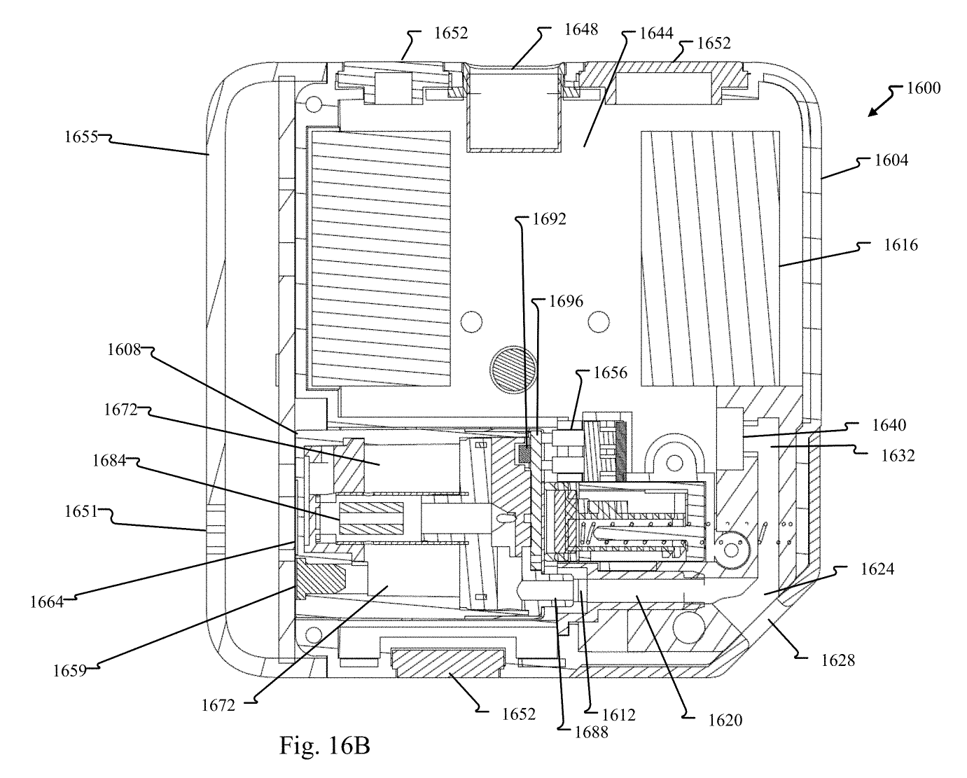

FIG. 16A depicts details of a single cartridge vaporizer device 1600 in accordance with at least one embodiment of the present disclosure. The single cartridge vaporizer device 1600 generally includes a single cartridge vaporizer device body 1604 with a cartridge cavity 1608. The cartridge cavity 1608 is configured to receive a cartridge 1664. The single cartridge vaporizer device body 1604 may include an airflow fitting 1612 coupling the airflow of the single cartridge vaporizer device body 1604 to the cartridge 1664, an airflow pathway 1620, and an airflow chamber 1624 coupled to the integrated mouthpiece 1628. The airflow chamber 1624 may be cylindrical in nature and may include a portion coupled to the airflow pathway 1620 and a sensor chamber portion 1632 coupled to a sensor chamber including a sensor 1640. The sensor 1640 may be the same as or similar to the previously described sensor 540. For example, the sensor 1640 may be a microphone configured to detect a pressure drop, differential, and/or puff or draw sound, of a puff or draw occurring at the mouthpiece 1628. That is, an area 1636 of the sensor 1640 that is opposite to the sensor chamber portion 1632 may provide an ambient air pressure, while the sensor chamber 1632, airflow chamber 1624, airflow pathway 1620, and airflow fitting 1612 coupling the airflow of the single cartridge vaporizer device body 1604 to the cartridge 1664 of the single cartridge vaporizer device body 1604 may be subject to a pressure drop due to an inhalation occurring at the mouthpiece 1628. Thus, a pressure drop, air flow, and/or pressure differential may be detected at sensor 1640 when a draw or puff is initiated until the puff or draw ends.

The single cartridge vaporizer device body 1604 may include the printed circuit board (PCB) assembly 1644 coupled to the USB interface 1648, input receiving device/indicator 1652, and/or the data and power interface 1656. The printed circuit board (PCB) assembly 1644 might be the same as or similar to the previously described printed circuit board 212; the USB interface 1648 may be the same as or similar to the previously described communication/charging interface 544; the input receiving device/indicator 1652 may be same as or similar to the previously described status/display indicator 536 and/or user input receiving device 532; and the data and power interface 1656 may be the same as or similar to the previously described communication interface 528 and/or power interface 524.

The data and power interface 1656, cartridge coupling assembly 1660, and the airflow fitting 1612 coupling the airflow of the single cartridge vaporizer device body 1604 to the cartridge 1664 may come into contact with the cartridge airflow coupler 1688 coupling the airflow of the cartridge 1664 to the single cartridge vaporizer device body 1604 when the cartridge 1664 is inserted into the cartridge cavity 1608. Accordingly, a cartridge coupling assembly 1660 may receive a cartridge coupling portion 1692 such that the cartridge 1664 remains fixedly attached to the single cartridge vaporizer device body 1604. Moreover, the data and power interface 1656 may make contact with contact portions 1696 of the cartridge 1664. The data and power interface 1656 may comprise a USB protocol connector. The contact portions 1696 may be the same as or similar to the previously described communication interface 440 and/or power interface 416. Accordingly, the memory 208 may be communicatively coupled to the printed circuit board (PCB) assembly 1644 via the contact portions 1696 and the data and power interface 1656. The data and power interface 1656 may include two pins for exchanging data and two pins for providing power.

The cartridge 1664 may include one or more injection holes 1668A-1668B for injecting a substance to be vaporized into the reservoir 1672. The cartridge 1664 may include an airflow connection 1676 coupling the cartridge 1664 to an outside or external air source. The cartridge 1664 may include a ceramic cylindrical atomizer with a hollow interior 1680 as part of a heating chamber 1684. The ceramic cylindrical atomizer with a hollow interior 1680 may include a semi porous structure such that once saturated with the substance to be vaporized, the substance is vaporized when heat is applied to the ceramic. Accordingly, the heating element 412 may be disposed within ceramic and may be part of the heating chamber 1684.

In accordance with at least one embodiment of the present disclosure, a controller/processor of the printed circuit board (PCB) 1644 may retrieve cartridge information from the cartridge 1664 and may receive a vaporizer cartridge vaporizing profile selection via the input receiving device/indicator 1652. The sensor 1640 of the single cartridge vaporizer device body 1604 may detect a draw or puff event, causing the controller/processor of the printed circuit board (PCB) assembly 1644 to provide a voltage and/or current from the battery 1616 to the heating chamber 1684 in accordance with the selected vaporizer cartridge vaporizing profile. Accordingly, air may from the airflow connection 1676, through the ceramic cylindrical atomizer with a hollow interior 1680 and heating chamber 1684, to the cartridge airflow coupler 1688 coupling the airflow of the cartridge 1664 to the single cartridge vaporizer device body 1604, airflow pathway 1620, airflow chamber 1624, and out the mouthpiece 1628.

FIG. 16B depicts a single cartridge vaporizer device 1601 with a substantially square shaped form factor in accordance with at least one embodiment of the present disclosure. The single cartridge vaporizer device 1601 may be similar to the device 1600 as discussed above and illustrated in FIG. 16A. The single cartridge vaporizer device 1601 generally includes a single cartridge vaporizer device body 1604 with a cartridge cavity 1608. The cartridge cavity 1608 is configured to receive a cartridge 1664. The vaporizer device 1601 may include a cartridge access door 1655 which may operate to rotate open to allow a user to insert a cartridge 1664 into the cartridge cavity 1608. The single cartridge vaporizer device body 1604 may include an airflow fitting coupling the airflow of the single cartridge vaporizer device body 1604 to the cartridge 1664, an airflow pathway 1620, and an airflow chamber 1624 coupled to the integrated mouthpiece 1628. The airflow chamber may be cylindrical in nature and may include a portion coupled to the airflow pathway 1620 and a sensor chamber portion 1632 coupled to a sensor chamber including a sensor 1640. The sensor 1640 may be the same as or similar to the previously described sensor 540. For example, the sensor 1640 may be a microphone configured to detect a pressure drop, differential, and/or puff or draw sound, of a puff or draw occurring at the mouthpiece 1628. That is, an area of the sensor 1640 that is opposite to the sensor chamber portion 1632 may provide an ambient air pressure, while the sensor chamber 1632, airflow chamber 1624, airflow pathway 1620, and airflow fitting 1612 coupling the airflow of the single cartridge vaporizer device body 1604 to the cartridge 1664 of the single cartridge vaporizer device body 1604 may be subject to a pressure drop due to an inhalation occurring at the mouthpiece 1628. Thus, a pressure drop, air flow, and/or pressure differential may be detected at sensor 1640 when a draw or puff is initiated until the puff or draw ends.

The single cartridge vaporizer device body 1604 may include a printed circuit board (PCB) assembly coupled to a USB interface 1648, input receiving device/indicator 1652, and/or the data and power interface 1656. The printed circuit board (PCB) assembly might be the same as or similar to the previously described printed circuit board 212; the USB interface 1648 may be the same as or similar to the previously described communication/charging interface 544; the input receiving device/indicator 1652 may be same as or similar to the previously described status/display indicator 536 and/or user input receiving device 532; and the data and power interface 1656 may be the same as or similar to the previously described communication interface 528 and/or power interface 524.

The data and power interface 1656, cartridge coupling assembly 1660, and the airflow fitting 1612 coupling the airflow of the single cartridge vaporizer device body 1604 to the cartridge 1664 may come into contact with the cartridge airflow coupler 1688 coupling the airflow of the cartridge 1664 to the single cartridge vaporizer device body 1604 when the cartridge 1664 is inserted into the cartridge cavity 1608. The data and power interface 1656 may make contact with contact portions 1696 of the cartridge 1664. The data and power interface 1656 may comprise a USB protocol connector. The contact portions 1696 may be the same as or similar to the previously described communication interface 440 and/or power interface 416. Accordingly, the memory 208 may be communicatively coupled to the printed circuit board (PCB) assembly via the contact portions 1696 and the data and power interface 1656. The data and power interface 1656 may include two pins for exchanging data and two pins for providing power.

The cartridge 1664 may include one or more injection holes for injecting a substance to be vaporized into one or more reservoirs 1672 of the cartridge 1664. The one or more injection holes may be capped by a fill plug 1659. The cartridge 1664 may include an airflow connection coupling the cartridge 1664 to an outside or external air source. The cartridge 1664 may include a ceramic cylindrical atomizer with a hollow interior as part of a heating chamber 1684. The ceramic cylindrical atomizer with a hollow interior 1680 may include a semi porous structure such that once saturated with the substance to be vaporized, the substance is vaporized when heat is applied to the ceramic. Accordingly, a heating element 412 may be disposed within ceramic and may be part of the heating chamber 1684.

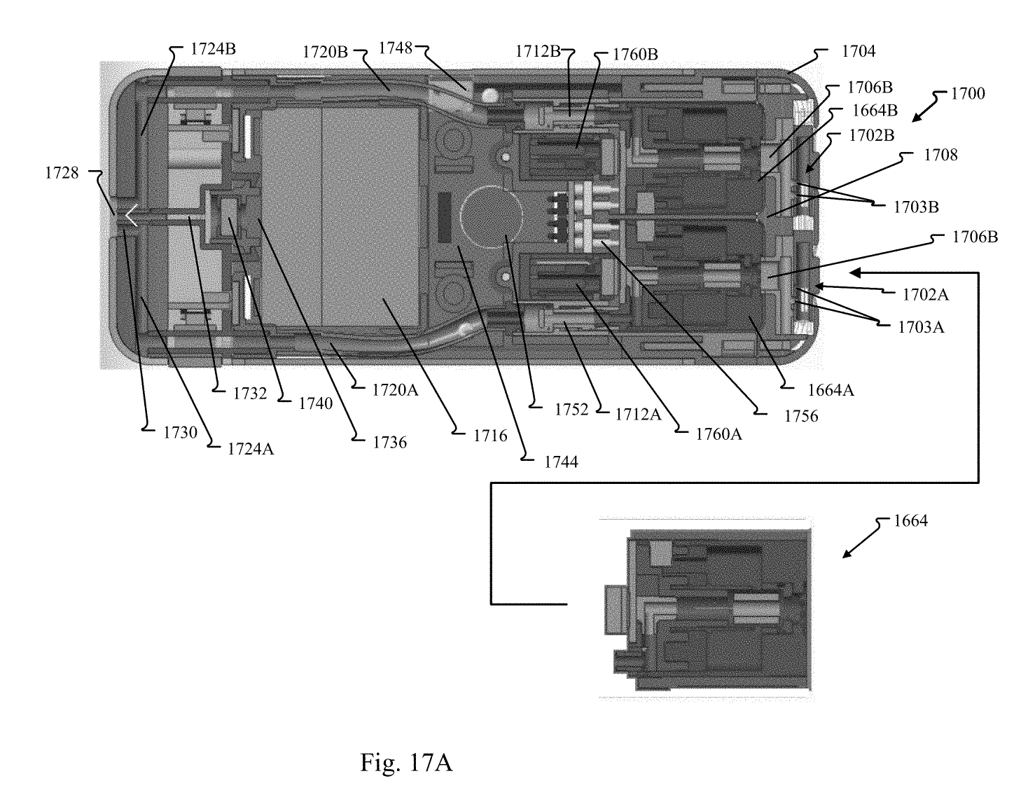

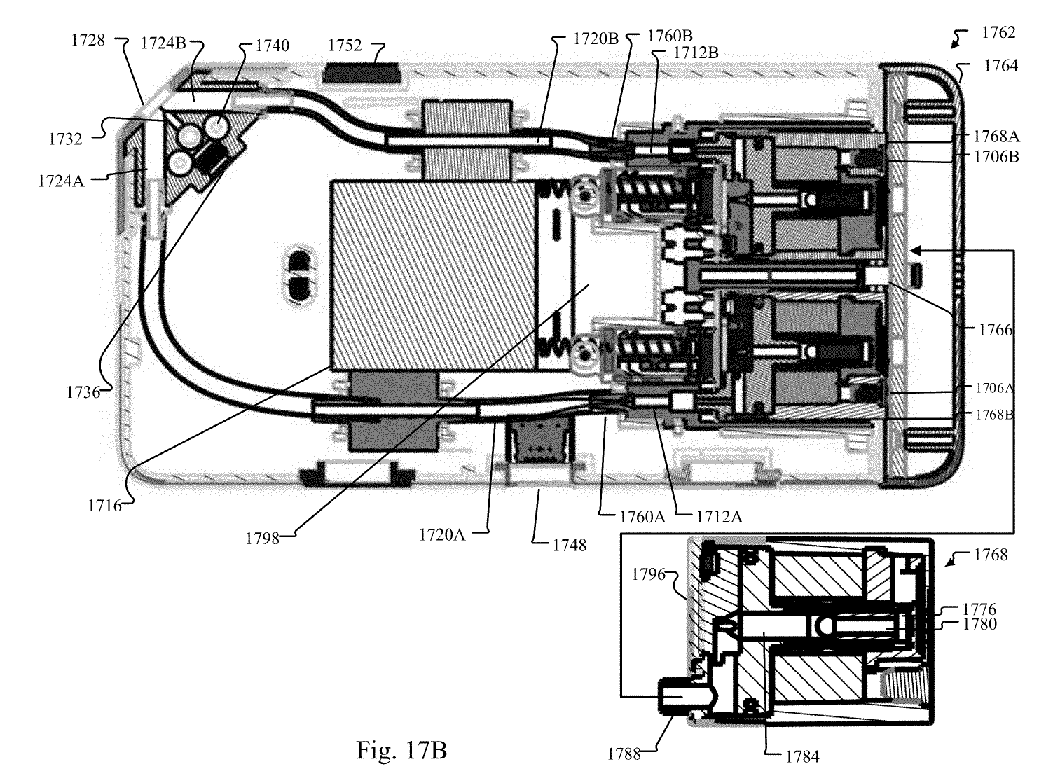

In accordance with at least one embodiment of the present disclosure, a controller/processor of the printed circuit board (PCB) may retrieve cartridge information from the cartridge 1664 and may receive a vaporizer cartridge vaporizing profile selection via the one or more input receiving devices/indicators 1652. The sensor 1640 of the single cartridge vaporizer device body 1604 may detect a draw or puff event, causing the controller/processor of the printed circuit board (PCB) assembly 1644 to provide a voltage and/or current from the battery 1616 to the heating chamber 1684 in accordance with the selected vaporizer cartridge vaporizing profile. Accordingly, air may from one or more air ports 1651 on the cartridge access door 1655, into the cartridge 1664, through the ceramic cylindrical atomizer with a hollow interior and heating chamber 1684, to the cartridge airflow coupler 1688 coupling the airflow of the cartridge 1664 to the single cartridge vaporizer device body 1604, airflow pathway 1620, airflow chamber 1624, and out the mouthpiece 1628. FIG. 17A depicts details of a multi-cartridge vaporizer device 1700 in accordance with at least one embodiment of the present disclosure. The multi-cartridge vaporizer device 1700 generally includes a dual cartridge vaporizer device body 1704 with a cartridge cavity 1708. Although the multi-cartridge vaporizer device 1700 could be configured to receive more than two cartridges, the cartridge cavity 1708 is configured to receive two cartridges 1664. The dual cartridge vaporizer device body 1704 may include two airflow fittings 1712A-1712B coupling the airflow of the dual cartridge vaporizer device body 1704 to the cartridges 1664, an airflow pathway 1720A-B1720B, and an airflow chamber 1724 coupled to an air mixing chamber 1730, where vapors from each of the cartridges 1664 are mixed prior to passing through the integrated mouthpiece 1728. The airflow chamber 1724 may be cylindrical in nature, or any other shape conducive to mixing vapors, and may include a portion coupled to the airflow pathway 1720A-B1720B and a sensor chamber portion 1732 coupled to a sensor chamber including a sensor 1740. The air mixing chamber may also include baffles (not shown) to facility mixing of the incoming separate flows. The sensor 1740 may be the same as or similar to the previously described sensor 540. For example, the sensor 1740 may be a microphone configured to detect a pressure drop, differential, and/or puff or draw sound, of a puff or draw occurring at the mouthpiece 1728. That is, an area 1736 of the sensor 1740 that is opposite to the sensor chamber portion 1732 may provide an ambient air pressure, while the sensor chamber 1732, airflow chamber 1724, airflow pathway 1720A-1720B, and airflow fittings 1712A-1712B coupling the airflow of the dual cartridge vaporizer device body 1704 to the cartridges 1664 of the dual cartridge vaporizer device body 1704 may be subject to a pressure drop due to an inhalation occurring at the mouthpiece 1728. Thus, a pressure drop, air flow, and/or pressure differential may be detected at sensor 1740 when a draw or puff is initiated until the puff or draw ends.

The dual cartridge vaporizer device body 1704 may include the printed circuit board (PCB) assembly 1744 coupled to the USB interface 1748, input receiving device/indicator 1752, and/or the data and power interface 1756. The printed circuit board (PCB) assembly 1744 may be the same or similar to the previously described printed circuit board 212; the USB interface 1748 may be the same as or similar to the previously described communication/charging interface 544; the input receiving device/indicator 1752 may be the same as or similar to the previously described status/display indicator 536 and/or user input receiving device 532; and the data and power interface 1756 may be the same as or similar to the previously described communication interface 528 and/or power interface 524, except that the data and power interface 1756 is configured to be coupled to two cartridges 1664.

The data and power interface 1756, cartridge coupling assembly 1660, and the airflow fittings 1712A-1712B coupling the airflow of the dual cartridge vaporizer device body 1704 to the cartridges 1664 may come into contact with the cartridge airflow coupler 1688 when the cartridge 1664 is inserted into the cartridge cavity 1708. Accordingly, cartridge coupling assemblies 1760A-1760B may receive a cartridge coupling portion 1692 such that the cartridge 1664 remains fixedly attached to the dual cartridge vaporizer device body 1704. Moreover, the data and power interface 1756 may make contact with contact portions 1696 of the cartridges 1664. The data and power interface 1656 may comprise a USB protocol connector. Accordingly, the memory 208 of each cartridge 1664 may be communicatively coupled to the printed circuit board (PCB) assembly 1744 via the contact portions 1696 and the data and power interface 1756. The data and power interface 1756 may include two pins for exchanging data and two pins for providing power for each of the cartridge 1664.

In accordance with at least one embodiment of the present disclosure, a controller/processor of the printed circuit board (PCB) 1744 may retrieve cartridge information from the cartridges 1664 and may receive a vaporizer cartridge vaporizing profile selection for each cartridge via the input receiving device/indicator 1752. The sensor 1740 of the dual cartridge vaporizer device body 1704 may detect a draw or puff event, causing the controller/processor of the printed circuit board (PCB) assembly 1744 to provide a voltage and/or current from the battery 1716 to the heating chambers 1684 of each cartridge 1664 in accordance with the selected vaporizer cartridge vaporizing profile. Accordingly, air may from the airflow connection 1676 of each cartridge 1664, through the ceramic cylindrical atomizer with a hollow interior 1680 and heating chamber 1684, to the cartridge airflow coupler 1688 coupling the airflow of the cartridge 1664 to the dual cartridge vaporizer device body 1704, airflow pathway 1720A-1720B, airflow chamber 1724, air mixing chamber 1730, and out the mouthpiece 1728.

The dual cartridge vaporizer device body 1704 may include one or more slide assemblies for controlling an amount of airflow to a respective cartridge 1664. That is, the slide assembly 1702A and 1702B include a sliding portion that may cover, in part or in whole, one or more holes 1703A-1703B coupled to each of the respective airflow couplers 1706A-1706B. Accordingly, an amount of air that may flow through the airflow coupler 1706A may be different from an amount of air that may flow through the airflow coupler 1706B. Accordingly, an amount of vapor originating from the cartridge 1664B may be different from an amount of vapor originating from the cartridge 1664A.

FIG. 17B depicts details of a multi-cartridge vaporizer device 1762 in accordance with at least one embodiment of the present disclosure. The multi-cartridge vaporizer device 1762 generally includes a dual cartridge vaporizer device body 1764 with a cartridge cavity 1766. Although the multi-cartridge vaporizer device 1762 could be configured to receive more than two cartridges, the cartridge cavity 1766 is configured to receive two cartridges 1768. The dual cartridge vaporizer device body 1764 may include two airflow fittings 1712A-1712B coupling the airflow of the dual cartridge vaporizer device body 1764 to the cartridges 1768, an airflow pathway 1720A-1720B, and an airflow chamber 1724A-1724B an integrated mouthpiece 1728. The airflow chamber 1724A-1724B may be cylindrical in nature, or any other shape conducive to mixing vapors, and may include a sensor chamber portion 1732 coupled to a sensor chamber including a sensor 1740. The air mixing chamber may also include baffles (not shown) to facility mixing of the incoming separate flows. The sensor 1740 may be the same as or similar to the previously described sensor 540. For example, the sensor 1740 may be a microphone configured to detect a pressure drop, differential, and/or puff or draw sound, of a puff or draw occurring at the mouthpiece 1728. That is, an area 1736 of the sensor 1740 that is opposite to the sensor chamber portion 1732 may provide an ambient air pressure, while the sensor chamber 1732, airflow chamber 1724A-1724B, airflow pathway 1720A-1720B, and airflow fittings 1712A-1712B coupling the airflow of the dual cartridge vaporizer device body 1764 to the cartridges 1768 of the dual cartridge vaporizer device body 1764 may be subject to a pressure drop due to an inhalation occurring at the mouthpiece 1728. Thus, a pressure drop, air flow, and/or pressure differential may be detected at sensor 1740 when a draw or puff is initiated until the puff or draw ends.

The dual cartridge vaporizer device body 1764 may include a printed circuit board (PCB) assembly 1798 coupled to the USB interface 1748, input receiving device/indicator 1752, and/or the data and power interface. The printed circuit board (PCB) assembly may be the same or similar to the previously described printed circuit board 212; the USB interface 1748 may be the same as or similar to the previously described communication/charging interface 544; the input receiving device/indicator 1752 may be the same as or similar to the previously described status/display indicator 536 and/or user input receiving device 532; and the data and power interface may be the same as or similar to the previously described communication interface 528 and/or power interface 524, except that the data and power interface is configured to be coupled to two cartridges 1768.

The data and power interface, cartridge coupling assembly 1760A-1760B, and the airflow fittings 1712A-1712B coupling the airflow of the dual cartridge vaporizer device body 1764 to the cartridges 1768 may come into contact with the cartridge airflow coupler when the cartridge 1768 is inserted into the cartridge cavity 1766. Accordingly, cartridge coupling assemblies 1760A-1760B may receive a cartridge coupling portion such that the cartridge 1768 remains fixedly attached to the dual cartridge vaporizer device body 1764. Moreover, the data and power interface may make contact with contact portions of the cartridges 1768. The data and power interface may comprise a USB protocol connector. Accordingly, the memory 208 of each cartridge 1768 may be communicatively coupled to the printed circuit board (PCB) assembly via the contact portions 1796 and the data and power interface. The data and power interface may include two pins for exchanging data and two pins for providing power for each of the cartridge 1768.

In accordance with at least one embodiment of the present disclosure, a controller/processor of the printed circuit board (PCB) may retrieve cartridge information from the cartridges 1768 and may receive a vaporizer cartridge vaporizing profile selection for each cartridge via the input receiving device/indicator 1752. The sensor 1740 of the dual cartridge vaporizer device body 1764 may detect a draw or puff event, causing the controller/processor of the printed circuit board (PCB) assembly to provide a voltage and/or current from the battery 1716 to the heating chambers 1784 of each cartridge 1768 in accordance with the selected vaporizer cartridge vaporizing profile. Accordingly, air may flow from the airflow connection 1776 of each cartridge 1768, through the ceramic cylindrical atomizer with a hollow interior 1780 and heating chamber 1784, to the cartridge airflow coupler 1788 coupling the airflow of the cartridge 1768 to the dual cartridge vaporizer device body 1764, airflow pathway 1720A-1720B, airflow chamber 1724, and out the mouthpiece 1728.

The dual cartridge vaporizer device body 1764 may include one or more flow control assemblies for controlling an amount of airflow to a respective cartridge 1768. The control assembly may be a mechanical slide assembly as describe in connection with other embodiments or other mechanisms, valves, restrictors, throttles known to those of skill in the art for controlling fluid flow. Accordingly, an amount of air that may flow through the airflow coupler 1706A may be different from an amount of air that may flow through the airflow coupler 1706B. Accordingly, an amount of vapor originating from the cartridge 1768A may be different from an amount of vapor originating from the cartridge 1768B.

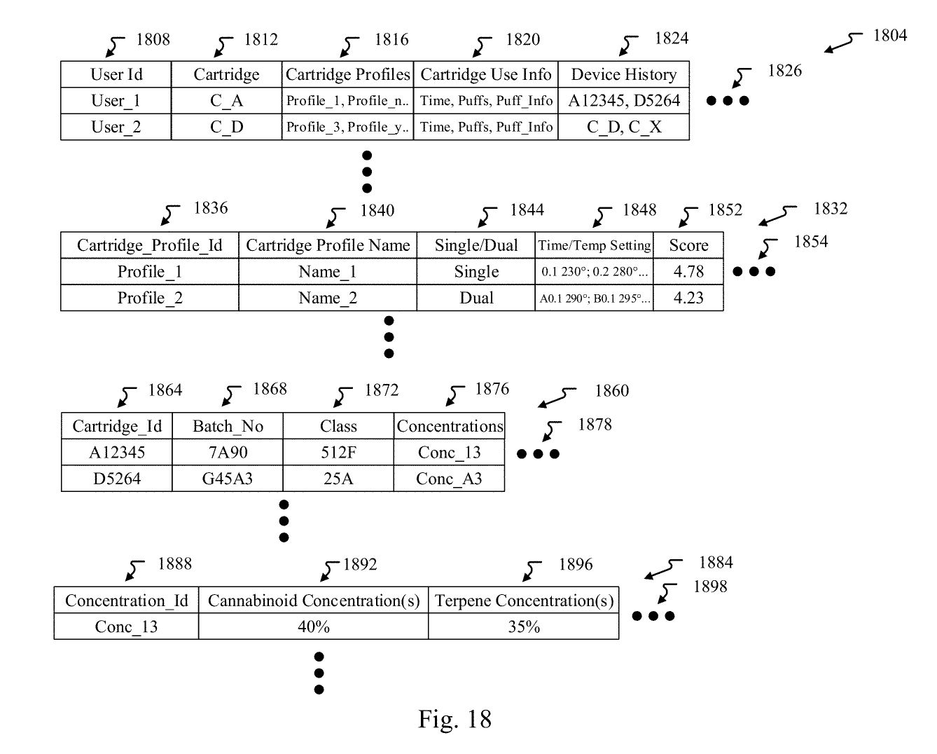

Referring now to FIG. 18, details of one or more data structures utilized by the vaporizer device 104, the vaporizer cartridge 106, application, or app, 128 executing on the communication device 108, and/or the crowd sourced data platform 132 are depicted in accordance with at least one embodiment of the present disclosure. The data structure 1804 may correspond generally to a top-level data structure including information about a user, cartridge, cartridge profiles, cartridge user information, and device history. For example, the data structure 1804 may include a first field 1808 which includes user-identifying information. Such information may be the same as or similar to the user-identifying information in user account details 904. Moreover, the data structure 1804 may include cartridge information 1812 identifying one or more cartridges used by a vaporizer device 104. The data structure 1804 may also include one or more cartridge profiles 1816 that identifies one or more vaporizer cartridge vaporizing profiles associated with a user 120, vaporizer device 104, vaporizer cartridge 106, and/or user profile 124. The data structure 1804 may include a cartridge use field 1820; the cartridge use field 1820 may identify and/or include information related to the use of a cartridge, such as that which was discussed previously with respect to cartridge information 1116. In addition, the data structure 1804 may include a device history field 1824 which includes overall device use information including which vaporizer device 104 and which vaporizer cartridge 106 have been used by a user 120. Of course, additional information 1826 may be included in the data structure 1804.

A data structure 1832 generally providing information related to one or more vaporizer cartridge vaporizing profile may be utilized. The data structure 1832 may include a vaporizer cartridge vaporizing profile identifier 1836, a customized vaporizer cartridge vaporizing profile name 1840, a field indicating whether the profile is identified in 1836 is applicable to a single, dual, or both vaporizer device 1844. Moreover, the data structure 1832 may include specific time and temperature settings 1848, where the specific time and temperature settings may correspond to one or more temperature setpoints, such as temperature set points 1212A-1212H, of the vaporizer cartridge vaporizing profile. Further, the data structure 1832 may include the ranking or rating field 1852 and include a rating or ranking as previously discussed. The data structure 1832 may include additional information 1854 related to the vaporizer cartridge vaporizing profile.

The data structure 1860 generally includes information fields related to a specific vaporizer cartridge 1664. For example, the data structure 1860 may include a cartridge identifier field 1864 which uniquely identifies a vaporizer cartridge 1664. Additional information may include a batch number 1868, a classification of the vaporizer cartridge 1664, and a reference to a concentration profile identifier 1876. In accordance with at least one embodiment of the present disclosure, one or more default vaporizer cartridge vaporizing profiles 434 may be provided to the vaporizer cartridge 404 based on the classification of the vaporizer cartridge 404. Similar to a batch identifier 1868, the class 1872 may include multiple cartridges identified by their cartridge identifier. Accordingly, one or more default vaporizer cartridge vaporizing profiles 434 may be sent to all vaporizer cartridge 404 based on the classification. The data structure 1860 may include additional information 1878 related to the vaporizer cartridge.

The data structure 1884 generally includes information identifying substances and concentrations for a specific cartridge 1664. For example, the concentration field 1876 may link to the concentration identifier 1888 which may provide specific concentrations of substances within the cartridge 1664. For example, a cannabinoid concentration 1892 may be provided, a terpene concentration 1896 may be provided, and other concentrations 1898 may be provided.

Each of the data structure 1804, data structure 1832, data structure 1860, and data structure 1884, in whole or in part, may reside at the memory 424, memory 512, memory 608, database 648, memory 712, and/or database 744.

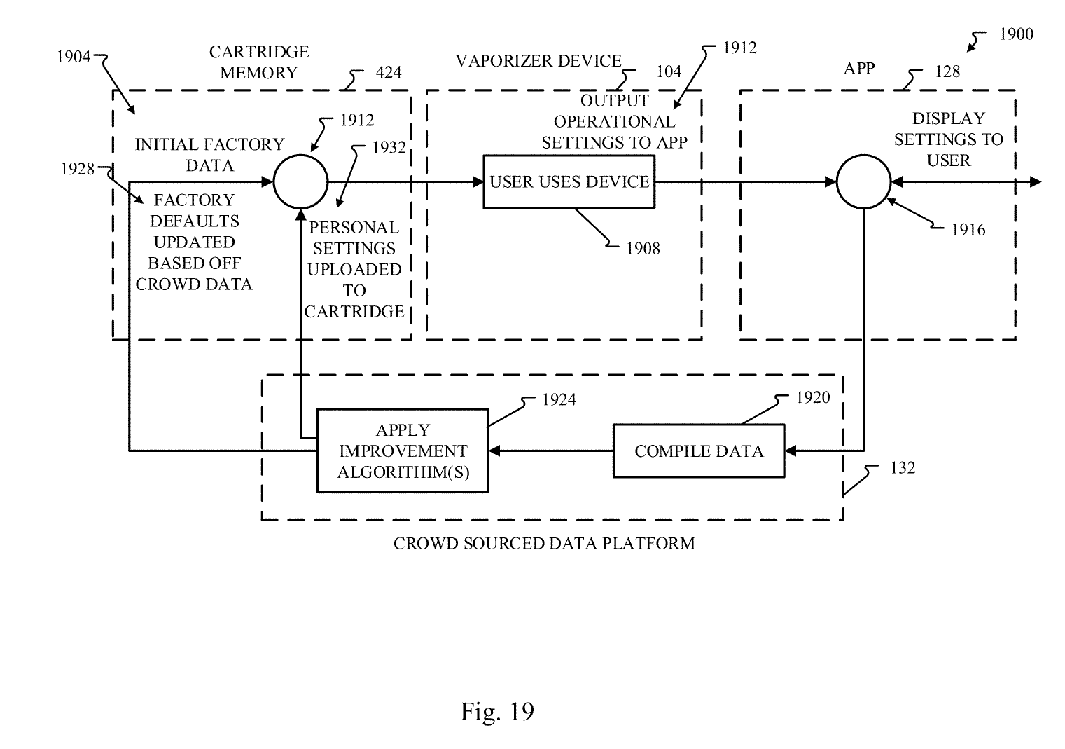

FIG. 19 depicts details of one or more processes 1900 utilized in connection with the crowd sourced data platform 132 in accordance with at least one embodiment of the present disclosure. Initial manufacturer or factory data 1904 may reside at the memory 424 of the vaporizer cartridge. A user may use the vaporizer device 104 at 1908 where the operation settings may be output to the application, or app, 128 executing on the communication device 108 at 1912. At 1916, the application, or app, 128 executing on the communication device 108 may display one or more of the previously described configuration settings of the vaporizer cartridge vaporizing profile to a user, where a user may change one or more setpoints, such as temperature set points 1212A-1212H. Accordingly, at 1916, the application, or app, 128 executing on the communication device 108 may provide the temperature setpoints and additional profile information to the crowd sourced data platform 132, where the crowd sourced data platform 132 may compile data for vaporizer cartridge vaporizing profiles for cartridges of the same classification, as previously discussed with respect to the field 1872 of the data structure 1860. At 1924, the crowd sourced data platform 132 may process such data in order to arrive at a new vaporizer cartridge vaporizing profile. For example, the crowd sourced data platform 132 may average all user provided vaporizer cartridge vaporizing profile for a vaporizer cartridge 404 of the same class. Alternatively, or in addition, the crowd sourced data platform 132 may average all user provided vaporizer cartridge vaporizing profile for a vaporizer cartridge 404 of the same class and having a rating above a threshold value, for example four stars. Alternatively, or in addition, the crowd sourced data platform 132 may process the data such that the previously provided default vaporizer cartridge vaporizing profile is weighted heavier in the processing, where minor adjustments may be made based on user provided data. Alternatively, or in addition, one or more machine learning algorithms may be applied to the data such that a default vaporizer cartridge vaporizing profile based on user characteristics, such as, but not limited to, location, user status, time of day, and other user identifying characteristics may provide a processed vaporizer cartridge vaporizing profile. Accordingly, at 1928, the default vaporizer cartridge vaporizing profile 434 may be provided to the first memory location 428 for example, where the first memory location 428 is a default or memory location for manufacturer provided vaporizer cartridge vaporizing profiles. Alternatively, or in addition, at 1932, one or more of the vaporizer cartridge vaporizing profiles may be provided to the second memory location 432.

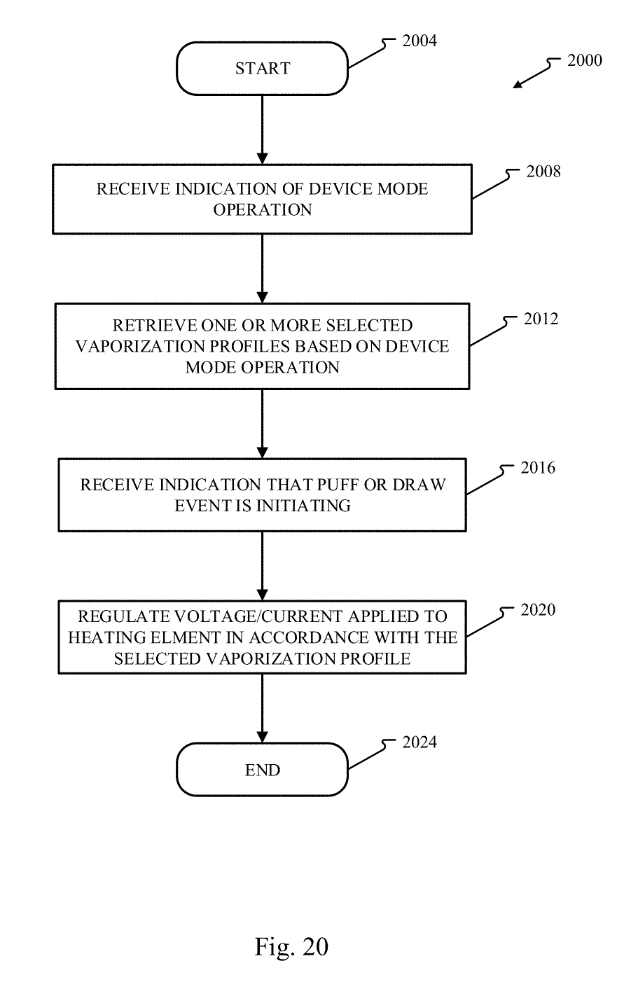

FIG. 20 depicts a first flow or process diagram of a method for operating a vaporizer device in accordance with at least one embodiment of the present disclosure. The method 2000 is in embodiments performed by one or more devices, such as the vaporizer device 104 and/or vaporizer cartridge 106. More specifically, one or more hardware and software components including the controller/logic circuit 504 may be involved in performing the method 2000. The method 2000 may be executed as a set of processor-executable instructions, executed by the controller/logic circuit 504 and encoded or stored on a computer-readable medium, such as memory 512. Hereinafter, the method 2000 shall be explained with reference to systems, components, modules, etc. described with reference to FIGS. 1-19.

Method 2000 may continuously flow in a loop, flow according to a timed event, or flow according to a change in an operating or status parameter. Method 2000 is initiated at step 2004 where a vaporizer device 104 may be turned on or otherwise activated. At step 2008, an indication of a device mode operation may be received. That is, the user input receiving device 532 may receive a specific indication as to whether the vaporizer device 104 is to operate in a default profile mode, user profile mode, application or app mode, or constant setting mode. If the user input receiving device 532 together with the controller/logic circuit 504 determines that the vaporizer device 104 is to operate in accordance with a default profile mode or user profile mode, the method 2000 may proceed to step 2012 where one or more selected default profiles or user profiles are retrieved from the vaporizer cartridge 106. For example, the controller/logic circuit 504 may operate to retrieve a default vaporizer cartridge vaporizing profile 434 or a user-provided vaporizer cartridge vaporizing profile 436. At step 2016, the controller/logic circuit 504 may receive an indication from the sensor 540 that a puff or draw event is initiating. Accordingly, the controller/logic circuit 504 may utilize the regulator 520 to set a first temperature of the heating element 412 in accordance with a first temperature setpoint of the retrieved vaporizer cartridge vaporizing profile. After a passage of a period of time, and in accordance with the retrieved vaporizer cartridge vaporizing profile, the controller/logic circuit 504 may utilize the regulator 520 to set a second temperature of the heating element 412 in accordance with a second temperature setpoint of the retrieved vaporizer cartridge vaporizing profile at step 2020. Of course, it should be understood that rather than temperature, the regulator 520 may achieve one or more setpoints, where the one or more setpoints are current, voltage, wattage, etc. Accordingly, the regulator 520 may regulate a current, voltage, and/or power to achieve such setpoints. The method 2000 may end at step 2024.

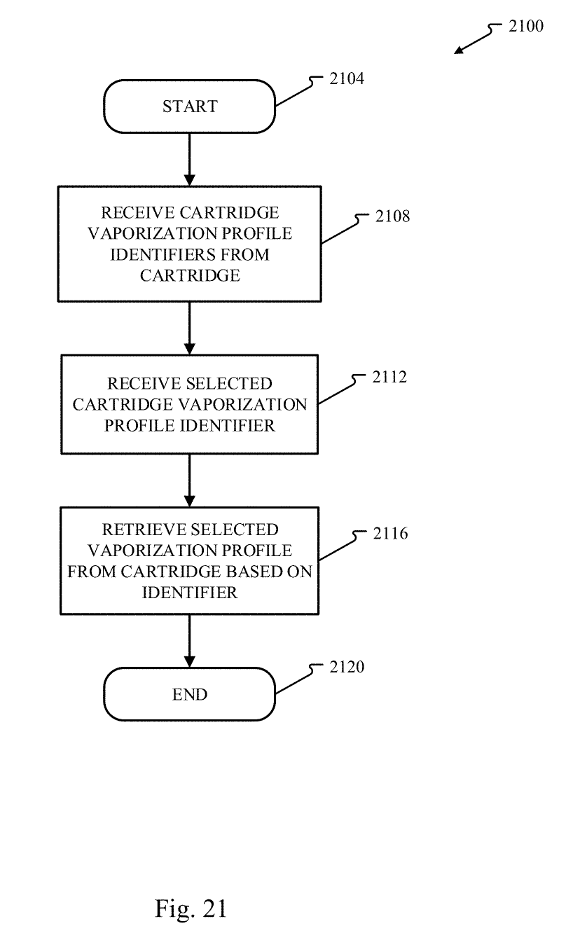

FIG. 21 depicts a second flow or process diagram of a method for retrieving a vaporizer cartridge vaporizing profile from the vaporizer cartridge 106 in accordance with at least one embodiment of the present disclosure. The method 2100 is in embodiments performed by one or more devices, such as the vaporizer device 104 and/or vaporizer cartridge 106. More specifically, one or more hardware and software components including the controller/logic circuit 504 and memory 424 may be involved in performing the method 2100. The method 2100 may be executed as a set of processor-executable instructions, executed by the controller/logic circuit 504 and encoded or stored on a computer-readable medium, such as memory 512. Hereinafter, the method 2100 shall be explained with reference to systems, components, modules, etc. described with reference to FIGS. 1-20.

Method 2100 may continuously flow in a loop, flow according to a timed event, or flow according to a change in an operating or status parameter. Method 2100 is initiated at step 2104 where a vaporizer device 104 may be turned on or otherwise activated. At step 2108, the controller/logic circuit 504 of the vaporizer device 104 may communicate with the memory 424 of the vaporizer cartridge 404 to retrieve vaporizer cartridge vaporizing profile identifiers from the vaporizer cartridge 106. Accordingly, a user may utilize the user input receiving device 532 to cycle through the retrieved vaporizer cartridge vaporizing profiles. For instance, the status/display indicator 536 may display a specific color, pattern, or otherwise in accordance with a vaporizer cartridge vaporizing profile. Once a vaporizer cartridge vaporizing profile is selected at step 2112, the vaporizer device 104 may retrieve the selected profile from the first memory location 428 or second memory location 432, in whole or in part, at step 2116. The method 2100 may end at step 2120.

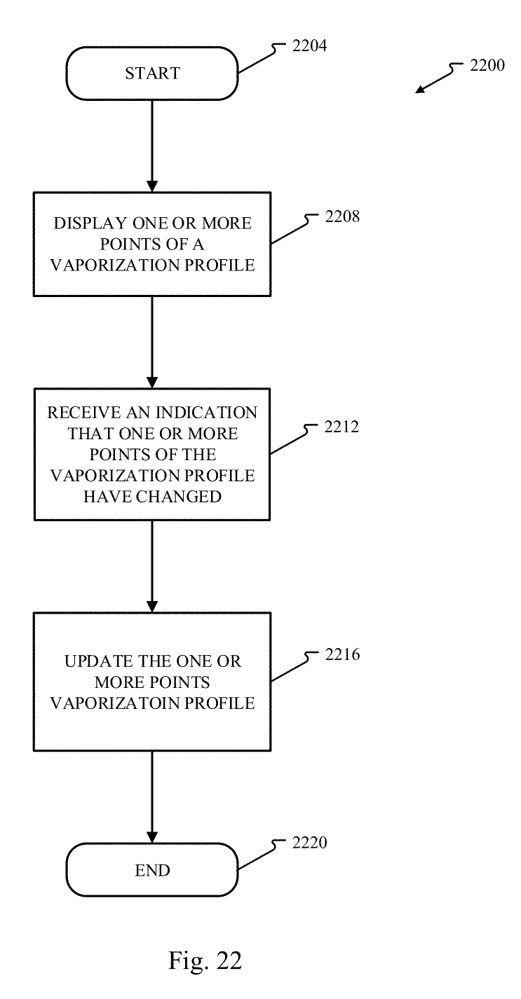

FIG. 22 depicts a third flow or process diagram of a method for changing one or more setpoints on a vaporizer cartridge vaporizing profile in accordance with at least one embodiment of the present disclosure. The method 2200 is in embodiments performed by one or more devices, such as the application, or app, 128 executing on the communication device 108. More specifically, one or more hardware and software components including the processor/controller 604 and memory 608 may be involved in performing the method 2200. The method 2200 may be executed as a set of processor-executable instructions, executed by the processor/controller 604 and encoded or stored on a computer-readable medium, such as memory 608. Hereinafter, the method 2200 shall be explained with reference to systems, components, modules, etc. described with reference to FIGS. 1-21.

Method 2200 may continuously flow in a loop, flow according to a timed event, or flow according to a change in an operating or status parameter. Method 2200 is initiated at step 2204 where a user may select one or more options to edit or create a vaporizer cartridge vaporizing profile. At step 2208, one or more points of a vaporizer cartridge vaporizing profile may be displayed to a user. For example, the fifth user interface 1200 may be displayed to a user, where the temperature set points 1208A-1208H are displayed. At step 2212, an indication that one or more of the setpoints may be received. That is, one or more of the temperature set points 1208A-1208H may be changed such that the vaporizer cartridge vaporizing profile includes temperature set points 1212A-1212H. Thus, at step 2216, the vaporizer cartridge vaporizing profile may be updated with the one or more temperature setpoints. The method 2200 may end at step 2220.

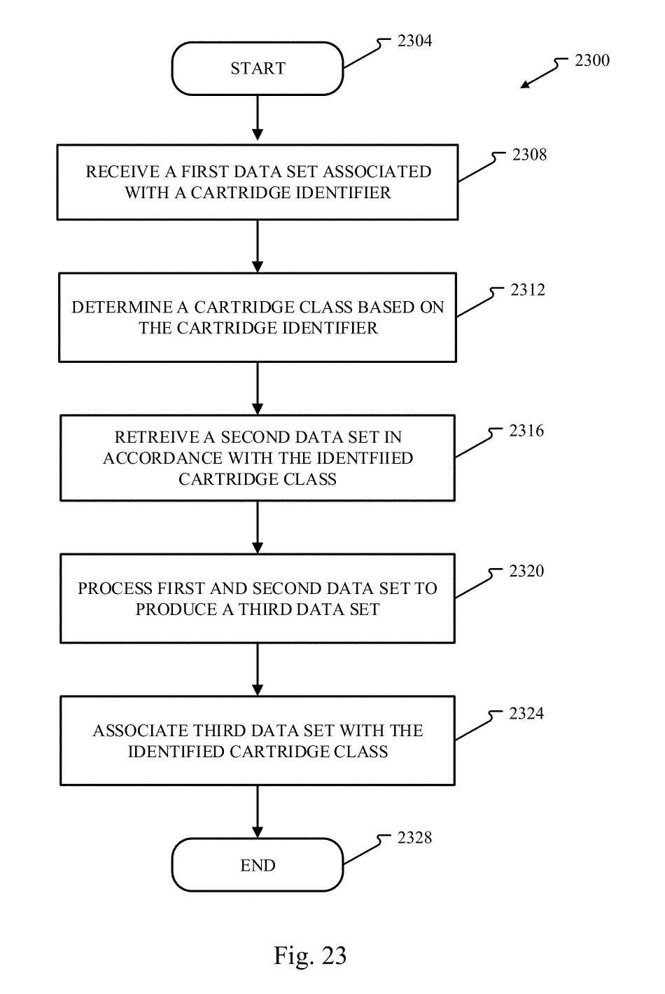

FIG. 23 depicts a fourth flow or process diagram of a method for assembling one or more crowd sourced vaporizer cartridge vaporizing profile in accordance with at least one embodiment of the present disclosure. The method 2300 is in embodiments performed by one or more devices, such as the one or more application/data servers 144. More specifically, one or more hardware and software components including the processor/controller 708 and memory 712 may be involved in performing the method 2300. The method 2300 may be executed as a set of processor-executable instructions, executed by the processor/controller 708 and encoded or stored on a computer-readable medium, such as memory 712. Hereinafter, the method 2300 shall be explained with reference to systems, components, modules, etc. described with reference to FIGS. 1-22.

Method 2300 may continuously flow in a loop, flow according to a timed event, or flow according to a change in an operating or status parameter. Method 2300 is initiated at step 2304 where an indication that new crowd sourced vaporizer cartridge vaporizing profile is to be created based on received data. Thus, at step 2308, the crowd sourced data platform 132 may receive a first set of data and a cartridge identifier. At step 2312, the cartridge identifier may be utilized to identify a specific classification of the cartridge. At step 2316, a second data set may be retrieved. The second data set may be associated with the identified cartridge class. At step 2320, the first and second data sets may be processed such that a third data set is created. For example, the crowd sourced data platform 132 may average all user provided vaporizer cartridge vaporizing profile for a vaporizer cartridge 404 of the same class. Alternatively, or in addition, the crowd sourced data platform 132 may average all user provided vaporizer cartridge vaporizing profile for a vaporizer cartridge 404 of the same class and having a rating above a threshold value, for example four stars. Alternatively, or in addition, the crowd sourced data platform 132 may process the data such that the previously provided default vaporizer cartridge vaporizing profile is weighted heavier in the processing, where minor adjustments may be made based on user provided data in the first data set. Alternatively, or in addition, one or more machine learning algorithms may be applied to the data such that a default vaporizer cartridge vaporizing profile based on user characteristics, such as, but not limited to, location, user status, time of day, and other user identifying characteristics may provide a processed vaporizer cartridge vaporizing profile in step 2320. At step 2324, the resulting vaporizer cartridge vaporizing profile may be associated with the cartridge classifier such that cartridges associated with the classifier may receive the crowd sourced vaporizer cartridge vaporizing profile, as either a default profile or as a user selected profile. The method 2300 may end at step 2328.

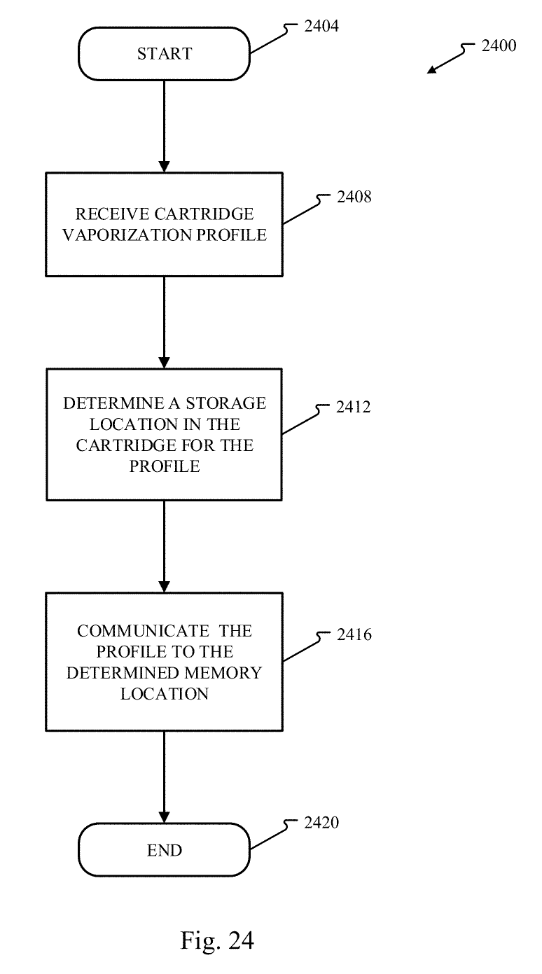

FIG. 24 depicts a fifth flow or process diagram of a method for synchronizing or otherwise updating one or more vaporizer cartridge vaporizing profile in accordance with at least one embodiment of the present disclosure. The method 2400 is in embodiments performed by one or more devices, such as the vaporizer device 104 and/or vaporizer cartridge 106. More specifically, one or more hardware and software components including the controller/logic circuit 504, memory 508, and memory 424 may be involved in performing the method 2400. The method 2400 may be executed as a set of processor-executable instructions, executed by the controller/logic circuit 504 and encoded or stored on a computer-readable medium, such as memory 508. Hereinafter, the method 2400 shall be explained with reference to systems, components, modules, etc. described with reference to FIGS. 1-23.

Method 2400 may continuously flow in a loop, flow according to a timed event, or flow according to a change in an operating or status parameter. Method 2400 is initiated at step 2404 where an indication to update one or more vaporizer cartridge vaporizing profiles is received at the vaporizer device 104. Accordingly, at step 2408, the vaporizer device 104 may receive the new vaporization profile information. The new vaporization profile information may be provided from the application, or app, 128 executing on the communication device 108. At step 2412, the controller/logic circuit 504 may determine a storage location in the memory 424 based on a profile type. For example, if the vaporizer cartridge vaporizing profile is a default vaporizer cartridge vaporizing profile 434, then the controller/logic circuit 504 may determine that the new profile information should be stored in the first memory location 428. Alternatively, if the vaporizer cartridge vaporizing profile is a user provided vaporizer cartridge vaporizing profile 436, then the controller/logic circuit 504 may determine that the new profile information should be stored in the second memory location 432. Thus, at step 2416, the controller/logic circuit 504 may communicate or otherwise store the new profile in the determined memory location. The method 2400 may end at step 2420.

While various embodiments of the system have been described in detail, it is apparent that modifications and alterations of those embodiments will occur to those skilled in the art. For example, one or more teachings found in U.S. Patent Publication No. 2018/0043114, published Feb. 15, 2018, the entire disclosure of which is hereby incorporated herein by reference for all that it teaches and for all purposes, may be applied to one or more embodiments described herein. As another example, one or more teachings found in U.S. Patent Publication No. 2014/0366898, published on Dec. 19, 2014, the entire disclosure of which is hereby incorporated herein by reference for all that it teaches and for all purposes, may be applied to one or more embodiments described herein. As another example, one or more teachings found in U.S. Patent Publication No. 2015/0258289, published on Sep. 17, 2015, the entire disclosure of which is hereby incorporated herein by reference for all that it teaches and for all purposes, may be applied to one or more embodiments described herein. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having,” and variations thereof herein are meant to encompass the items listed thereafter and equivalents thereof, as well as, additional items.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably and include any type of methodology, process, mathematical operation or technique.

what is claimed is:

1. A vaporizer device comprising:
a body comprising:
a mouthpiece;
a power source;
a regulator coupled to the power source;
a cavity configured to receive a vaporizer cartridge;
one or more airflow pathways configured to interconnect with an airflow coupler associated with a vaporizer cartridge;
one or more user input devices; and
a data interface coupled to a processor, the data interface configured to contact a receiving portion of a vaporizer cartridge when the vaporizer cartridge is inserted into the cavity.

2. The vaporizer device according to claim 1, further comprising a sensor configured to detect a pressure change in the one or more airflow pathways between the vaporizer cartridge and the mouthpiece.

3. The vaporizer device according to claim 2, further comprising:
a controller configured to control the regulator.

4. The vaporizer device according to claim 3, wherein the data interface is configured to contact a receiving portion of a second vaporizer cartridge when both vaporizer cartridges are inserted into the cavity.

5. The vaporizer device according to claim 2, further comprising:
a controller configured to control the regulator; and
a power interface coupled to the regulator, the power interface configured to contact a receiving portion of a vaporizer cartridge when the vaporizer cartridge is inserted into the cavity.

6. The vaporizer device according to claim 5, wherein the power interface is configured to contact a receiving portion of a second vaporizer cartridge when both vaporizer cartridges are inserted into the cavity.

7. The vaporizer device according to claim 1, further comprising:
a controller including a processor and memory, the memory including one or more instructions, which when executed by the processor, cause the processor to communicate with the vaporizer cartridge when the vaporizer cartridge is inserted into the cavity.

8. The vaporizer device according to claim 1, further comprising:
a vaporizer cartridge removably connected to the cavity, the vaporizer cartridge comprising:
a reservoir containing a vaporizable material;
an atomizer for vaporizing the vaporizable material; and
an airflow coupler in fluid communication with the one or more airflow pathways of the body and the reservoir.

9. The vaporizer device according to claim 8, wherein the vaporizer cartridge includes a cartridge memory, and wherein the cartridge memory is configured to receive at least one operating parameter provided from a processor of a controller.

10. The vaporizer device according to claim 9, wherein the at least one operating parameter provided from the processor of the controller is an operating profile including a plurality of set points, each set point of the plurality of set points corresponding to an amount of heat to be generated by a heating element of the vaporizer cartridge at a point in time.

11. The vaporizer device according to claim 9, wherein the controller is configured to retrieve at least a portion of an operating profile from the cartridge memory, wherein the at least a portion of the operating profile includes a plurality of set points, each set point of the plurality of set points corresponding to an amount of heat to be generated by a heating element of the vaporizer cartridge at a point in time.

12. The vaporizer device according to claim 11, wherein the controller is configured to control the regulator and the heating element of the vaporizer cartridge in accordance with the operating profile.

13. The vaporizer device according to claim 11, further comprising an input receiving device coupled to the controller, wherein the operating profile is selected based on an input received from input receiving device.

14. The vaporizer device according to claim 10, further comprising a communication interface configured to receive the at least one operating profile.

15. The vaporizer device according to claim 14, wherein the vaporizer device is paired with a communication device, and wherein the communication device provides the vaporizer device with the at least one operating profile.

16. The vaporizer device according to claim 1, wherein a first of the one or more user input devices is a four-way toggle button.

17. The vaporizer device according to claim 16, wherein a second of the one or more user input devices is configured to be used in combination with the four-way toggle button to make a selection.

18. The vaporizer device according to claim 1, comprising one or more of an accelerometer and a gyroscopic sensor, wherein the one or more of an accelerometer and a gyroscope sensor is configured to determine at least one of lifting of the vaporizer device, lowering of the vaporizer device, and movement of the vaporizer device following a predetermined period in which the vaporizer device is motionless.

19. The vaporizer device according to claim 18, wherein the one or more of an accelerometer and a gyroscopic sensor senses a quantitative vertical distance of movement of the vaporizer device.

20. The vaporizer device according to claim 19, wherein the processor alerts a communication device based on the determination that the vaporizer device is lifted by the user.

21. A vaporizer cartridge comprising:
a reservoir;
a heating element configured to vaporize a substance in the reservoir;
an airflow path for removing vapor from proximate the heating element;
a data interface;
a power interface coupled to the heating element; and
a memory coupled to the data interface, wherein the memory includes a plurality of operating profiles,
wherein the vaporizer cartridge is configured to be removably connected to a receiving cavity of a vaporizer device, and wherein the airflow path is configured to communicate with an airflow path in the vaporizer device.

22. The vaporizer cartridge according to claim 21, wherein the vaporizer cartridge is configured to communicate at least a portion of a selected operating profile to a controller of the vaporizer device.

23. The vaporizer cartridge according to claim 22, wherein the memory includes a plurality of memory portions, a first memory portion of the plurality of memory portions is configured to store at least one default operating profile and a second memory portion of the plurality of memory portions is configured to store at least one user provided operating profile.

24. The vaporizer cartridge according to claim 23, wherein the default operating profile resides in the first memory portion prior to the vaporizer cartridge being inserted into the receiving cavity of the vaporizer device for a first time.

25. The vaporizer cartridge according to claim 21, wherein the data interface, power interface, and airflow path are disposed on the same side of the vaporizer cartridge.

26. A vaporizer device comprising:
a vaporizer device body including:
a mouthpiece disposed at a first end of the body;
a power source;
a regulator coupled to the power source;
a controller configured to control the regulator;
a cavity disposed at a second end of the body, wherein the second end is opposite the first end, the cavity configured to receive a vaporizer cartridge;
one or more airflow having a first end and a second end, the first end in fluid communication with the mouthpiece and the second end in fluid communication with an airflow fitting;
one or more user input devices; and
one or more of an accelerometer and a gyroscope sensor; and
the vaporizer cartridge inserted into the cavity, the vaporizer cartridge including:
a reservoir;
a heating element configured to vaporize a substance in the reservoir;
at least one airflow connector in fluid communication with the one or more airflow fittings of the body;
a data interface;
a power interface coupled to the heating element; and
a memory coupled to the data interface, wherein the memory includes a plurality of operating profiles,
wherein the controller is configured to communicate with the memory utilizing the data interface such that the controller accesses a selected one of the plurality of operating profiles.

27. The vaporizer device according to claim 26, wherein the data interface, power interface and at least one airflow connector are disposed on the same side of the cartridge.

28. The vaporizer according to claim 26, further comprising two vaporizer cartridges disposed within the cavity of the body.
